(19) United States
(12) Patent Application Publication
(10) Pub. No.: US 2013/0176920 A1
(43) Pub. Date: Jul. 11, 2013

(54) METHOD AND APPARATUS FOR TRANSMITTING A PLURALITY OF PIECES OF RECEIPT ACKNOWLEDGEMENT INFORMATION IN A WIRELESS COMMUNICATION SYSTEM

(71) Applicants: Dong Youn Seo, Anyang-si (KR); Min Gyu Kim, Anyang-si (KR); Suck Chel Yang, Anyang-si (KR); Joon Kui Ahn, Anyang-si (KR)

(72) Inventors: Dong Youn Seo, Anyang-si (KR); Min Gyu Kim, Anyang-si (KR); Suck Chel Yang, Anyang-si (KR); Joon Kui Ahn, Anyang-si (KR)

(73) Assignee: LG ELECTRONICS INC., Seoul (KR)

(21) Appl. No.: 13/824,316

(22) PCT Filed: Sep. 16, 2011
(86) PCT No.: PCT/KR2011/006870

§ 371 Date: Mar. 15, 2013

Related U.S. Application Data
(60) Provisional application No. 61/383,739, filed on Sep. 17, 2010.
(60) Provisional application No. 61/389,710, filed on Oct. 4, 2010.
(60) Provisional application No. 61/406,580, filed on Oct. 26, 2010.
(60) Provisional application No. 61/411,889, filed on Nov. 9, 2010.

(51) Int. Cl. H04W 72/04

(52) U.S. Cl. CPC H04W 72/04
USPC 370/280

(57) ABSTRACT

Provided is a method and apparatus for transmitting acknowledgement/not-acknowledgement (ACK/NACK) of a user equipment to which a plurality of cells are assigned in a wireless communication system operating with time division duplex (TDD). The method includes: receiving a plurality of codewords via the plurality of serving cells; generating ACK/NACK information indicating reception acknowledgement for each codeword; bundling the generated ACK/NACK information; and transmitting the bundled ACK/NACK information, wherein the bundling is sequentially performed on a part or entirety of the generated ACK/NACK information until an amount of the ACK/NACK information is less than or equal to a predetermined transmission amount.

### TECHNICAL FIELD

The present invention relates to wireless communications, and more particularly, to a method and apparatus for transmitting a plurality of pieces of reception acknowledgment information by a user equipment in a wireless communication system operating with time division duplex (TDD).

### BACKGROUND ART

In order to maximize efficiency of limited radio resources, an effective transmission and reception scheme and various methods of utilization thereof have been proposed in a wireless communication system. A multiple-carrier system is one of systems considered in a next-generation wireless communication system. The multiple-carrier system implies a system which supports a broadband by aggregating one or more carriers having a bandwidth narrower than that of a desired broadband when a wireless communication system intends to support the broadband.

A wireless communication system such as conventional 3^{rd} generation partnership project (3GPP) long term evolution (LTE) uses a carrier of various bandwidths, but is a single-carrier system which uses one carrier. Meanwhile, a next-generation wireless communication system such as LTE-A may be a multiple-carrier system which uses a plurality of carriers by aggregating the carriers.

In the multiple-carrier system, a user equipment (UE) can receive a plurality of data units through a plurality of downlink carriers, and can feed back a plurality of pieces of reception acknowledgement information (i.e., acknowledgement/not-acknowledgement (ACK/NACK)) for the plurality of data units to a base station (BS).

The multiple-carrier system can operate with either frequency division duplex (FDD) or time division duplex (TDD). When operating with the FDD, uplink transmission and downlink transmission can be performed simultaneously in different frequency bands. When operating with the TDD, uplink transmission and downlink transmission can be performed in the same frequency band at different times, that is, can be performed in different subframes. When the multiple-carrier system operates with the TDD, there is a case where a data unit received in a plurality of downlink subframes for each of a plurality of downlink component carriers (DL CCs) must be transmitted in one uplink subframe of one uplink component (UL CCs). In this case, an amount of ACK/NACK information that must be fed back by the UE may be increased in comparison with the conventional single-carrier system.

Accordingly, if the single-carrier system operates with the TDD, there is a need for another ACK/NACK transmission method and apparatus different from the conventional ACK/NACK transmission method.

### SUMMARY OF INVENTION

### Technical Problem

The present invention provides a method and apparatus for transmitting a plurality of pieces of reception acknowledgment information in a wireless communication system operating with time division duplex (TDD).

### Technical Solution

According to an aspect of the present invention, a method of transmitting acknowledgement/not-acknowledgement (ACK/NACK) of a user equipment to which a plurality of cells are assigned in a wireless communication system operating with time division duplex (TDD) is provided. The method includes: receiving a plurality of codewords via the plurality of serving cells; generating ACK/NACK information indicating reception acknowledgement for each codeword; bundling the generated ACK/NACK information; and transmitting the bundled ACK/NACK information, wherein the bundling is sequentially performed on a part or entirety of the generated ACK/NACK information until an amount of the ACK/NACK information is less than or equal to a predetermined transmission amount.

In the aforementioned aspect of the present invention, the plurality of serving cells may be identified by a carrier indication field value, and the bundling may be performed on ACK/NACK information for a plurality of codewords received in the same downlink subframe starting from a serving cell of which a carrier indication field value is the greatest among the plurality of serving cells.

In addition, a serving cell of which a carrier indication field value is the smallest among the plurality of serving cells may be a primary cell, and the primary cell may be subjected to bundling at the end.

In addition, the bundling may be performed with ACK if all of the plurality of codewords are successfully received in the same downlink subframe with respect to at least one serving cell among the plurality of serving cells, and otherwise may be performed with NACK.

In addition, the bundled ACK/NACK information may be transmitted by using any one of a channel selection mechanism based on physical uplink control channel (PUCCH) resource selection and a mechanism of using a PUCCH format 3.

According to another aspect of the present invention, a method of transmitting ACK/NACK of a user equipment to which a plurality of serving cells are assigned in a wireless communication system operating with TDD is provided. The method includes: receiving at least one codeword via a first serving cell; receiving at least one codeword via a second serving cell; and transmitting ACK/NACK for the codewords received via the first serving cell and the second serving cell, wherein the first serving cell and the second serving cell have an M:1 relation (where M is a natural number) between a downlink subframe for receiving the codewords and an uplink subframe mapped to the downlink subframe and for transmitting ACK/NACK, wherein if M is 1, ACK/NACK for the plurality of codewords received in the same subframe is transmitted, and wherein if M is greater than 1, ACK/NACK for the plurality of codewords received in the same subframe is transmitted by performing bundling.

In the aforementioned aspect of the present invention, the first serving cell may be a primary cell, and a first physical downlink control channel (PDCCH) for scheduling a codeword received via the first serving cell and a second PDCCH for scheduling a codeword received via the second serving cell may be received via the primary cell.

In addition, a plurality of radio resources may be allocated so that ACK/NACK for codewords received via the first serving cell and the second serving cell can be received on the basis of a radio resource for receiving the first PDCCH and a radio resource for receiving the second PDCCH.

### Advantageous Effects

According to the present invention, a user equipment can effectively transmit acknowledgment (ACK)/not-acknowledgement (NACK) for a data unit received in a plurality of serving cells by using a limited physical uplink control channel (PUCCH) resource.

### DESCRIPTION OF DRAWINGS

FIG. 1 shows a wireless communication system.

FIG. 2 shows a structure of a radio frame in 3^{rd} generation partnership project (3GPP) long term evolution (LTE).

FIG. 3 shows an example of a resource grid for one downlink (DL) slot.

FIG. 4 shows an exemplary structure of a DL subframe.

FIG. 5 shows a structure of an uplink (UL) subframe.

FIG. 6 shows physical mapping of a physical uplink control channel (PUCCH) format and a control region.

FIG. 7 shows a PUCCH format 1b in 3GPP LTE in a normal cyclic prefix (CP) case.

FIG. 8 shows a PUCCH format 3 in a normal CP case.

FIG. 9 shows a process of transmitting a signal by using a PUCCH format 3.

FIG. 10 shows an example of performing hybrid automatic repeat request (HARQ) in frequency division duplex (FDD).

FIG. 11 shows an example of transmitting a downlink assignment index (DAI) in a wireless communication system operating with time division duplex (TDD).

FIG. 12 shows an example of comparing a single-carrier system and a multiple-carrier system.

FIG. 13 shows an example of cross-carrier scheduling.

FIG. 14 shows an acknowledgement/not-acknowledgement (ACK/NACK) transmission method according to an embodiment of the present invention.

FIG. 15 shows an example of Methods 1-1 and 1-2.

FIG. 16 shows an example of Methods 1-3 and 1-4.

FIG. 17 shows an example of Methods 2-1 and 2-2.

FIG. 18 shows an example of Methods 2-3 and 2-4.

FIG. 19 shows an example of applying the conventional method and the present invention in case of transmitting ACK/NACK by using a PUCCH format 3.

FIG. 20 shows an example of applying the conventional method and the present invention when transmitting ACK/NACK by using a channel selection mechanism based on PUCCH resource selection.

FIG. 21 is a block diagram showing a wireless communication system according to an embodiment of the present invention.

### MODE FOR INVENTION

The technology described below can be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), etc. The CDMA can be implemented with a radio technology such as universal terrestrial radio access (UTRA) or CDMA2000. The TDMA can be implemented with a radio technology such as global system for mobile communications (GSM)/general packet ratio service (GPRS)/enhanced data rate for GSM evolution (EDGE). The OFDMA can be implemented with a radio technology such as institute of electrical and electronics engineers (IEEE) 802.11 (Wi-Fi), IEEE 802.16 (WiMAX), IEEE 802.20, evolved UTRA (E-UTRA), etc. IEEE 802.16m is evolved from IEEE 802.16e, and provides backward compatibility with an IEEE 802.16e-based system. The UTRA is a part of a universal 3^{rd} mobile telecommunication system (UMTS). 3^{rd} generation partnership project (3GPP) long term evolution (LTE) is a part of an evolved UMTS (E-UMTS) using the E-UTRA. The 3GPP LTE uses the OFDMA in a downlink and uses the SC-FDMA in an uplink. LTE-advance (LTE-A) is evolved from the LTE. Although the following description focuses on LTE and LTE-A for clarity, the technical features of the present invention are not limited thereto.

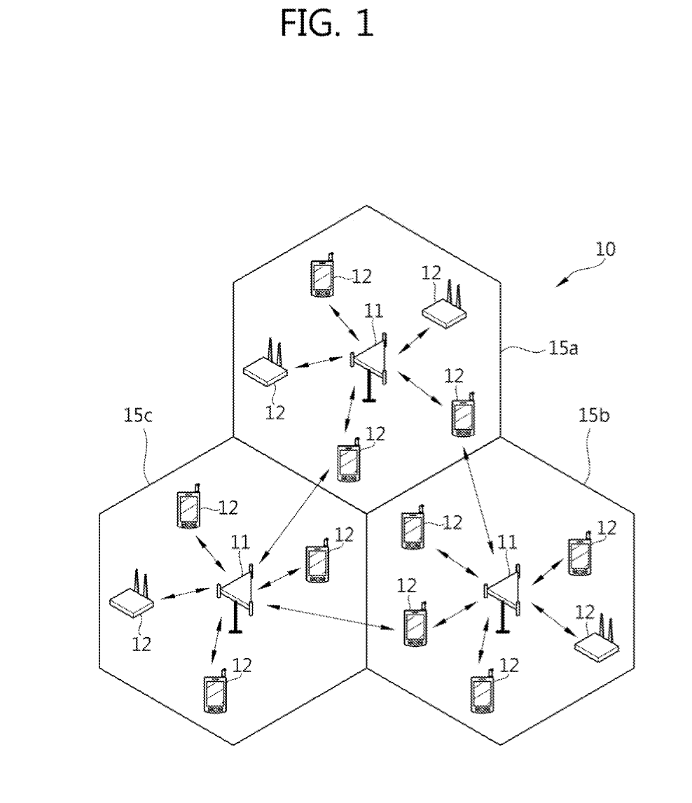

FIG. 1 shows a wireless communication system.

Referring to FIG. 1, a wireless communication system 10 includes at least one base station (BS) 11. Respective BSs 11 provide communication services to specific geographical regions 15a, 15b, and 15c. A user equipment (UE) 12 may be fixed or mobile, and may be referred to as another terminology, such as a mobile station (MS), an mobile terminal (MT), a user terminal (UT), a subscriber station (SS), a wireless device, a personal digital assistant (PDA), a wireless modem, a handheld device, etc.

The BS 11 is generally a fixed station that communicates with the UE 12 and may be referred to as another terminology, such as an evolved node-B (eNB), a base transceiver system (BTS), an access point, etc.

Hereinafter, a downlink implies communication from the BS 11 to the UE 12, and an uplink implies communication from the UE 12 to the BS 11. A wireless communication system can be briefly classified into a system based on a frequency division duplex (FDD) scheme and a system based on a time division duplex (TDD) scheme. In the FDD scheme, uplink transmission and downlink transmission are achieved while occupying different frequency bands. In the TDD scheme, uplink transmission and downlink transmission are achieved at different times while occupying the same frequency band

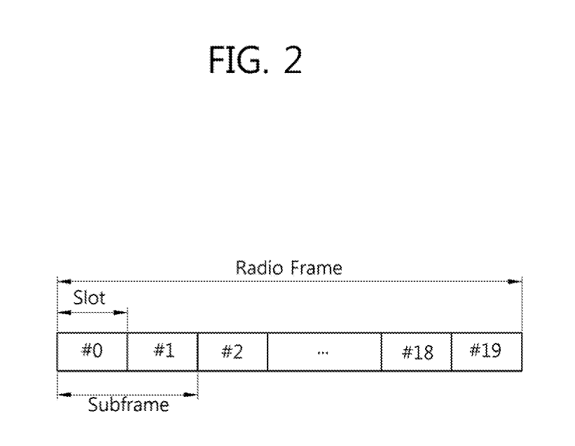

FIG. 2 shows a structure of a radio frame in 3GPP LTE.

Referring to FIG. 2, the radio frame consists of 10 subframes. One subframe consists of two slots. Slots included in the radio frame are numbered with slot numbers #0 to #19. A time required to transmit one subframe is defined as a transmission time interval (TTI). The TTI may be a scheduling unit for data transmission. For example, one radio frame may have a length of 10 milliseconds (ms), one subframe may have a length of 1 ms, and one slot may have a length of 0.5 ms.

One slot includes a plurality of orthogonal frequency division multiplexing (OFDM) symbols in a time domain. Since the 3GPP LTE uses OFDMA in downlink transmission, the OFDM symbol is for representing one symbol period, and can be referred to as other terms. For example, the OFDM symbol can also be referred to as an SC-FDMA symbol when SC-FDMA is used as a multiple-access scheme. In 3GPP LTE, it is defined such that one slot includes 7 OFDM symbols in a normal cyclic prefix (CP) case and one slot includes 6 OFDM symbols in an extended CP case.

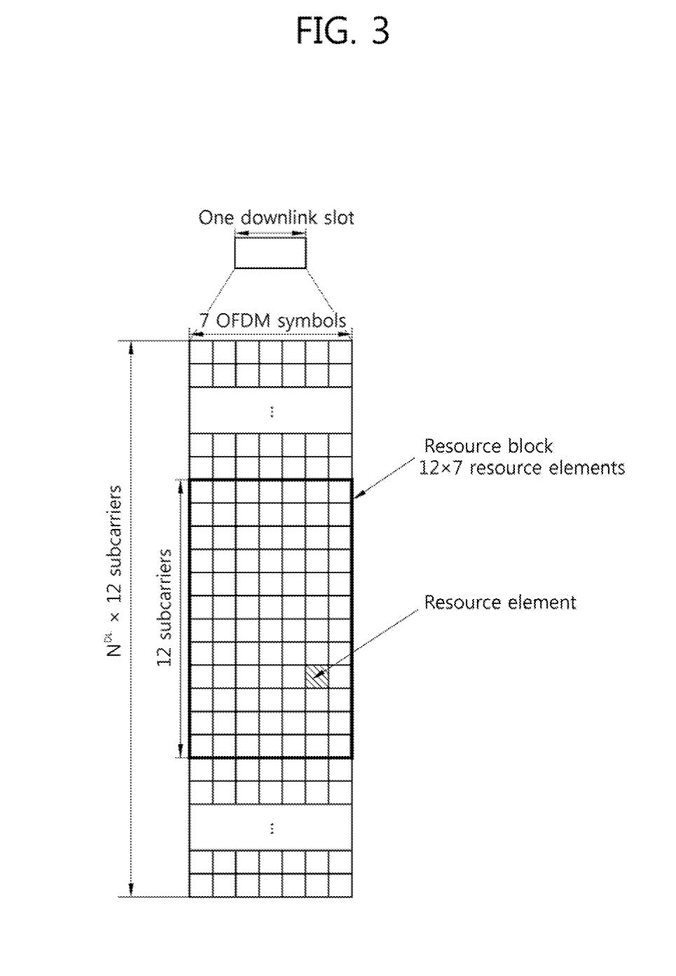

FIG. 3 shows an example of a resource grid for one downlink (DL) slot.

The DL slot includes a plurality of OFDM symbols in a time domain, and includes N_{RB} resource blocks (RBs) in a frequency domain. The RB includes a plurality of consecutive subcarriers in one slot in a unit of resource allocation. Although it is described in FIG. 3 that one RB consists of 7 OFDM symbols in the time domain and 12 subcarriers in the frequency domain for example, the present invention is not limited thereto. The number of OFDM symbols in the RB and the number of subcarriers may change variously depending on a CP length, a frequency spacing, etc. For example, the number of OFDM symbols is 7 in a normal CP case, and the number of OFDM symbols is 6 in an extended CP case. The number of subcarriers in one OFDM symbol may be selected from 128, 256, 512, 1024, 1536, and 2048. The number N_{RB} of RBs included in the DL slot depends on a DL transmission bandwidth configured in a cell. For example, in the LTE system, N_{RB} may be any one value in the range of 6 to 110.

Each element on the resource grid is referred to as a resource element (RE). The RE can be identified by an index pair (k,l) within the slot. Herein, k (k=0, . . . , N_{RB}×12-1) denotes a subcarrier index, and l (l=0, . . . , 6) denotes an OFDM symbol index.

A structure of an uplink (UL) slot may be the same as the aforementioned structure of the DL slot.

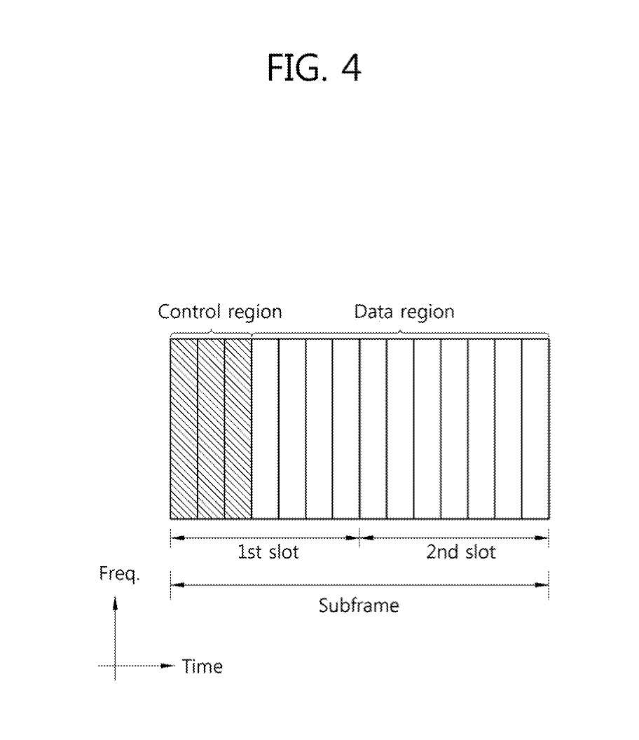

FIG. 4 shows an exemplary structure of a DL subframe.

The DL subframe includes two slots in a time domain, and each slot includes 7 OFDM symbols in a normal CP case. Up to three preceding OFDM symbols (i.e., in case of 1.4 MHz bandwidth, up to 4 OFDM symbols) of a first slot within the subframe correspond to a control region, and the remaining OFDM symbols correspond to a data region. Herein, control channels are allocated to the control region, and a physical downlink shared channel (PDSCH) is allocated to the data region.

A physical downlink control channel (PDCCH) can carry a downlink shared channel (DL-SCH)'s resource allocation and transmission format, uplink shared channel (UL-SCH)'s resource allocation information, paging information on a PCH, system information on a DL-SCH, a resource allocation of a higher layer control message such as a random access response transmitted through a PDSCH, a transmission power control command for individual UEs included in any UE group, activation of a voice over Internet (VoIP), etc. Control information transmitted through the PDCCH is referred to as downlink control information (DCI).

A plurality of PDCCHs can be transmitted in the control region, and a UE can monitor the plurality of PDCCHs. The PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). One REG includes 4 REs. One CCE includes 9 REGs. The number of CCEs used to configure one PDCCH may be selected from a set {1, 2, 4, 8}. Each element of the set {1, 2, 4, 8} is referred to as a CCE aggregation level. A format of the PDCCH and the number of bits of the available PDCCH are determined according to a correlation between the number of CCEs and the coding rate provided by the CCEs.

A BS determines a PDCCH format according to DCI to be transmitted to a UE, and attaches a cyclic redundancy check (CRC) to control information. The CRC is masked with a unique identifier (referred to as a radio network temporary identifier (RNTI)) according to an owner or usage of the PDCCH. If the PDCCH is for a specific UE, a unique identifier (e.g., cell-RNTI (C-RNTI)) of the UE may be masked to the CRC. Alternatively, if the PDCCH is for a paging message, a paging indicator identifier (e.g., paging-RNTI (P-RNTI)) may be masked to the CRC. If the PDCCH is for a system information block (SIB), a system information identifier and a system information RNTI (SI-RNTI) may be masked to the CRC. To indicate a random access response that is a response for transmission of a random access preamble of the UE, a random access-RNTI (RA-RNTI) may be masked to the CRC.

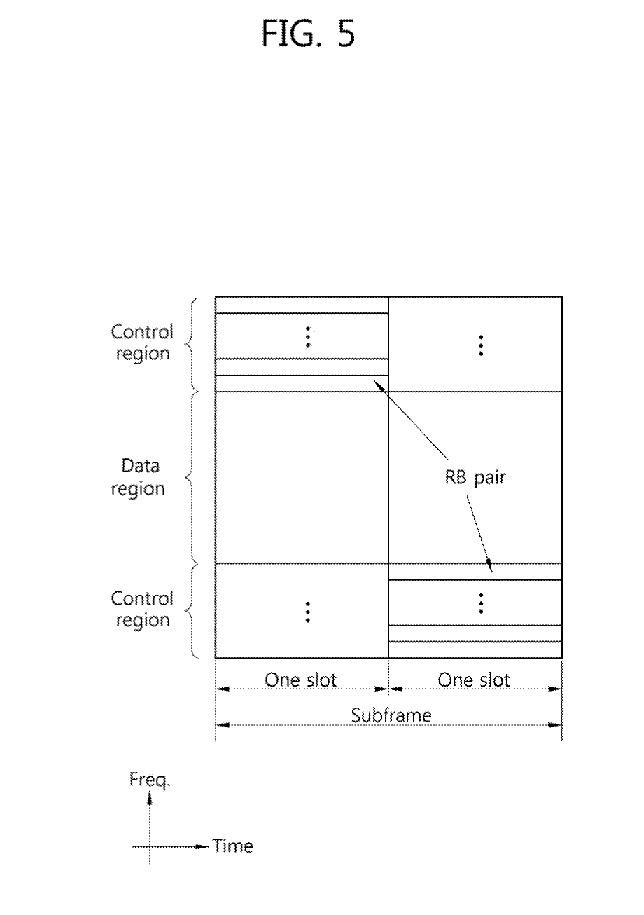

FIG. 5 shows a structure of a UL subframe.

The UL subframe can be divided into a control region and a data region. A physical uplink control channel (PUCCH) for carrying uplink control information (UCI) is allocated to the control region. A physical uplink shared channel (PUSCH) for carrying UL data and/or the UCI is allocated to the data region. In this sense, the control region can be called a PUCCH region, and the data region can be called a PUSCH region. According to configuration information indicated by a higher layer, a UE may support simultaneous transmission of the PUSCH and the PUCCH or may not support simultaneous transmission of the PUSCH and the PUCCH.

The PUSCH is mapped to an uplink shared channel (UL-SCH) which is a transport channel. UL data transmitted on the PUSCH may be a transport block which is a data block for the UL-SCH transmitted during TTI. Alternatively, the UL data may be multiplexed data. The multiplexed data may be attained by multiplexing control information and the transport block for the UL-SCH. Examples of the UCI to be multiplexed include a channel quality indicator (CQI), a precoding matrix indicator (PMI), a hybrid automatic repeat request (HARQ) acknowledgement/not-acknowledgement (ACK/NACK), a rank indicator (RI), a precoding type indication (PTI), etc. Only the UCI may be transmitted through the PUSCH.

The PUCCH for one UE is allocated in an RB pair in a subframe. RBs belonging to the RB pair occupy different subcarriers in each of a 1^{st} slot and a 2^{nd} slot. A frequency occupied by the RBs belonging to the RB pair changes at a slot boundary. This is called that the RB pair allocated to the PUCCH is frequency-hopped at the slot boundary. Since the UE transmits UCI on a time basis through different subcarriers, a frequency diversity gain can be obtained.

The PUCCH carries various types of control information according to a format. A PUCCH format 1 carries a scheduling request (SR). In this case, an on-off keying (OOK) scheme can be used. A PUCCH format 1a carries an acknowledgement/non-acknowledgement (ACK/NACK) modulated using bit phase shift keying (BPSK) with respect to one codeword (CW). A PUCCH format 1b carries an ACK/NACK modulated using quadrature phase shift keying (QPSK) with respect to two CWs. A PUCCH format 2 carries a channel quality indicator (CQI) modulated using QPSK. PUCCH formats 2a and 2b carry CQI and ACK/NACK. A PUCCH format 3 is modulated using QPSK, and can carry a plurality of ACK/NACK signals and an SR.

Table 1 shows a modulation scheme and the number of bits in a subframe according to a PUCCH format.

TABLE 1

| PUCCH format | Modulation scheme | Number of bits per subframe, M_{bit} |
|---|---|---|
| 1 | N/A | N/A |
| 1a | BPSK | 1 |
| 1b | QPSK | 2 |
| 2 | QPSK | 20 |
| 2a | QPSK + BPSK | 21 |
| 2b | QPSK + QPSK | 22 |

Although not shown in Table 1, the PUCCH format 3 can transmit up to 20-bit ACK/NACK.

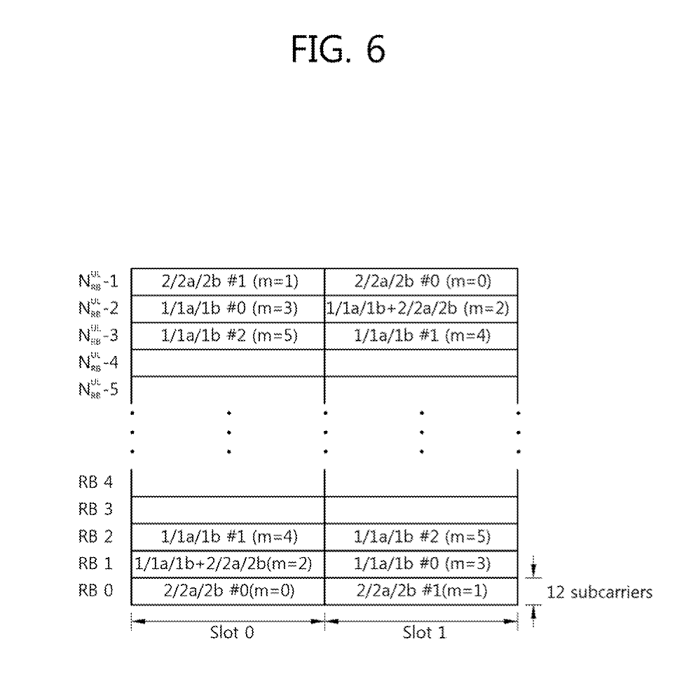

FIG. 6 shows physical mapping of a PUCCH format and a control region.

Referring to FIG. 6, PUCCH formats 2/2a/2b are mapped and transmitted on the band-edge RBs (e.g., PUCCH region m=0, 1). A mixed PUCCH RB can be transmitted by being mapped to an adjacent RB (e.g., m=2) towards a center of the band in an RB to which the PUCCH formats 2/2a/2b are allocated. PUCCH formats 1/1a/1b by which SR and ACK/NACK are transmitted can be deployed to an RB (e.g., m=4 or m=5).

All PUCCH formats use a cyclic shift (CS) of a sequence in each OFDM symbol. The cyclically shifted sequence is generated by cyclically shifting a base sequence by a specific CS amount. The specific CS amount is indicated by a CS index.

An example of a base sequence rᵤ(n) is defined by Equation 1 below.

rᵤ(n)=e^{jb(n)π/4} [Equation 1]

In Equation 1, u denotes a root index, and n denotes a component index in the range of 0≦n≦N−1, where N is a length of the base sequence. b(n) is defined in the section 5.5 of 3GPP TS 36.211 V8.7.0.

A length of a sequence is equal to the number of elements included in the sequence. u can be determined by a cell identifier (ID), a slot number in a radio frame, etc. When it is assumed that the base sequence is mapped to one RB in a frequency domain, the length N of the base sequence is 12 since one RB includes 12 subcarriers. A different base sequence is defined according to a different root index.

The base sequence r(n) can be cyclically shifted by Equation 2 below to generate a cyclically shifted sequence r(n, I_{cs}).

$$r ( n , {I}_{cs} ) = r ( n ) \cdot exp ( \frac{j2π {I}_{cs} n}{N} ) , O \leq {I}_{cs} \leq N - 1 \qquad [ Equation 2 ]$$

In Equation 2, I_{cs} denotes a CS index indicating a CS amount (0≦I_{cs}≦N−1).

The available CS of the base sequence denotes a CS index that can be derived from the base sequence according to a CS interval. For example, if the base sequence has a length of 12 and the CS interval is 1, the total number of available CS indices of the base sequence is 12. Alternatively, if the base sequence has a length of 12 and the CS interval is 2, the total number of available CS indices of the base sequence is 6.

Now, transmission of an HARQ ACK/NACK signal in PUCCH formats 1a/1b will be described.

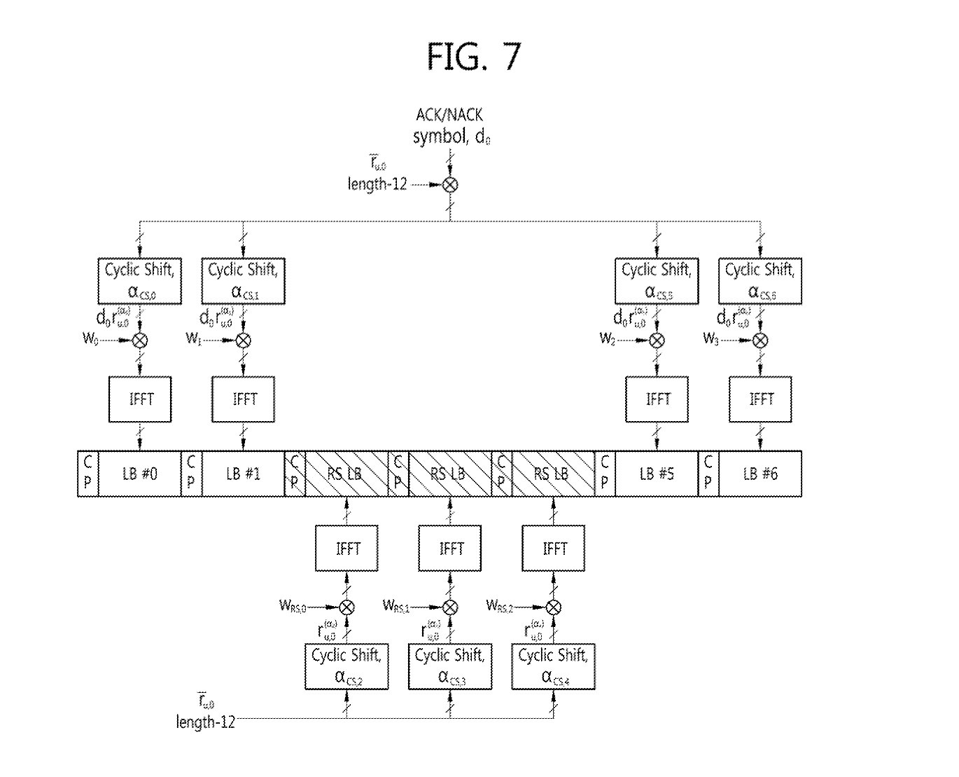

FIG. 7 shows a PUCCH format 1b in 3GPP LTE in a normal CP case.

One slot includes 7 OFDM symbols. Three OFDM symbols are used as a reference signal (RS) symbol for a reference signal. Four OFDM symbols are used as a data symbol for an ACK/NACK signal.

In the PUCCH format 1b, a modulation symbol d(0) is generated by modulating a 2-bit ACK/NACK signal based on quadrature phase shift keying (QPSK).

A CS index I_{cs} may vary depending on a slot number nₛ in a radio frame and/or a symbol index 1 in a slot.

In the normal CP case, there are four data OFDM symbols for transmission of an ACK/NACK signal in one slot. It is assumed that CS indices mapped to the respective data OFDM symbols are denoted by I_{cs0}, I_{cs1}, I_{cs2}, and I_{cs3}.

The modulation symbol d(0) is spread to a cyclically shifted sequence r(n,I_{cs}). When a one-dimensional spreading sequence mapped to an (i+1)^{th} OFDM symbol in a subframe is denoted by m(i), it can be expressed as follows.

{m(0), m(1), m(2), m(3)}={d(0)r(n,I_{cs0}), d(0)r(n,I_{cs1}), d(0)r(n,I_{cs2}), d(0)r(n,I_{cs3})}

In order to increase UE capacity, the one-dimensional spreading sequence can be spread by using an orthogonal sequence. An orthogonal sequence wᵢ(k) (where i is a sequence index, 0≦k≦K−1) having a spread factor K=4 uses the following sequence.

TABLE 2

| Index (i) | [wᵢ(0), wᵢ(1), wᵢ(2), wᵢ(3)] |
|---|---|
| 0 | [+1, +1, +1, +1] |
| 1 | [+1, −1, +1, −1] |
| 2 | [+1, −1, −1, +1] |

An orthogonal sequence wᵢ(k) (where i is a sequence index, 0≦k≦K−1) having a spread factor K=3 uses the following sequence.

TABLE 3

| Index (i) | [wᵢ(0), wᵢ(1), wᵢ(2)] |
|---|---|
| 0 | [+1, +1, +1] |
| 1 | [+1, c^{j2π/3}, c^{j4π/3}] |
| 2 | [+1, e^{j4π/3}, e^{j2π/3}] |

A different spread factor can be used for each slot.

Therefore, when any orthogonal sequence index i is given, two-dimensional spreading sequences {s(0), s(1), s(2), s(3)} can be expressed as follows.

{s(0), s(1), s(2), s(3)}={wᵢ(0)m(0), wᵢ(1)m(1), wᵢ(2)m(2), wᵢ(3)m(3)}

The two-dimensional spreading sequences {s(0), s(1), s(2), s(3)} are subjected to inverse fast Fourier transform (IFFT) and thereafter are transmitted in corresponding OFDM symbols. Accordingly, an ACK/NACK signal is transmitted on a PUCCH.

A reference signal of the PUCCH format 1b is also transmitted by cyclically shifting the base sequence r(n) and then by spreading it by the use of an orthogonal sequence. When CS indices mapped to three RS OFDM symbols are denoted by I_{cs4}, I_{cs5}, and I_{cs6}, three cyclically shifted sequences r(n,I_{cs4}), r(nI_{cs5}), and r(n,I_{cs6}) can be obtained. The three cyclically shifted sequences are spread by the use of an orthogonal sequence w^{RS}ᵢ(k) having a spreading factor K=3.

An orthogonal sequence index i, a CS index I_{cs}, and a resource block index m are parameters required to configure the PUCCH, and are also resources used to identify the PUCCH (or UE). If the number of available cyclic shifts is 12 and the number of available orthogonal sequence indices is 3, PUCCHs for 36 UEs in total can be multiplexed to one resource block.

In the 3GPP LTE, a resource index n⁽¹⁾_{PUCCH} is defined in order for the UE to obtain the three parameters for configuring the PUCCH. n⁽¹⁾_{PUCCH} is also called a PUCCH index. The resource index n⁽¹⁾_{PUCCH} is defined to n_{CCE}+N⁽¹⁾_{puccH}, where n_{CCE} is an index of a first CCE used for transmission of corresponding DCI (i.e., DL resource allocation used to receive DL data corresponding to an ACK/NACK signal), and N⁽¹⁾_{PUCCH} is a parameter reported by a BS to the UE by using a higher-layer message.

Time, frequency, and code resources used for transmission of the ACK/NACK signal are referred to as ACK/NACK resources or PUCCH resources. As described above, an index of a PUCCH resource or the ACK/NACK resource required to transmit the ACK/NACK signal on the PUCCH can be expressed with at least any one of an orthogonal sequence index i, a CS index I_{cs}, a resource block index m, and a PUCCH index n⁽¹⁾_{PUCCH} for obtaining the three indices.

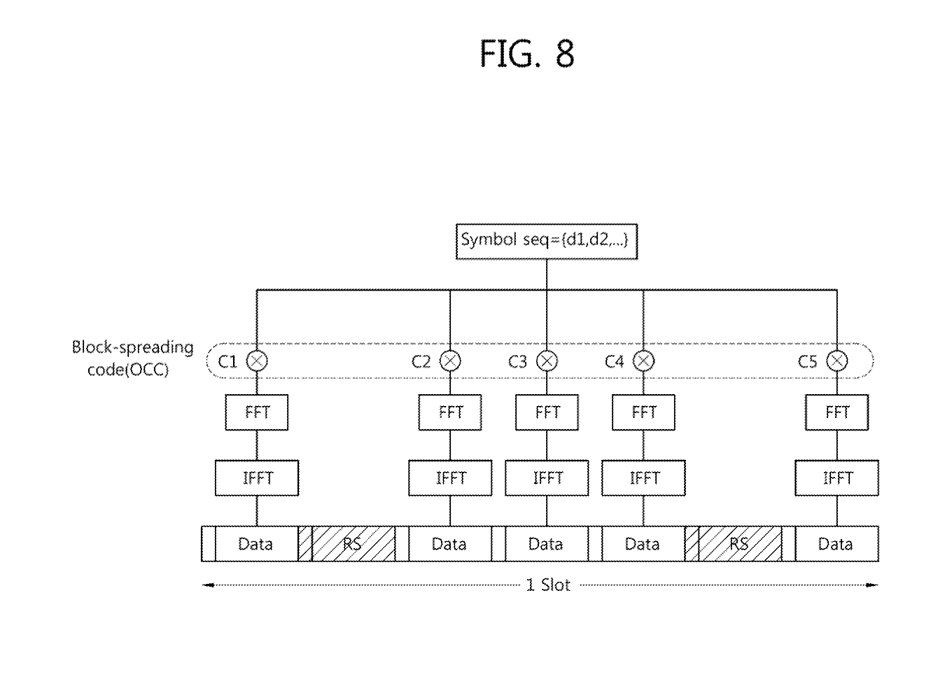

FIG. 8 shows a PUCCH format 3 in a normal CP case.

The PUCCH format 3 is a PUCCH format which uses a block spreading method. The block spreading method is a method of multiplexing a modulation symbol sequence modulated from multi-bit ACK/NACK by using a block spreading code. The block spreading method can use an SC-FDMA scheme. Herein, the SC-FDMA scheme is a scheme in which IFFT is performed after DFT spreading.

According to the PUCCH format 3, a symbol sequence is transmitted by being spread in a time domain by using a block spreading code. That is, in the PUCCH format 3, a symbol sequence consisting of one or more symbols is transmitted across a frequency domain of each data symbol, and is transmitted by being spread in the time domain by using the block spreading code. An orthogonal cover code may be used as the block spreading code.

Although a case where two RS symbols are included in one slot is exemplified in FIG. 8, the present invention is not limited thereto, and thus a case of including three RS symbols may also be included in the present invention.

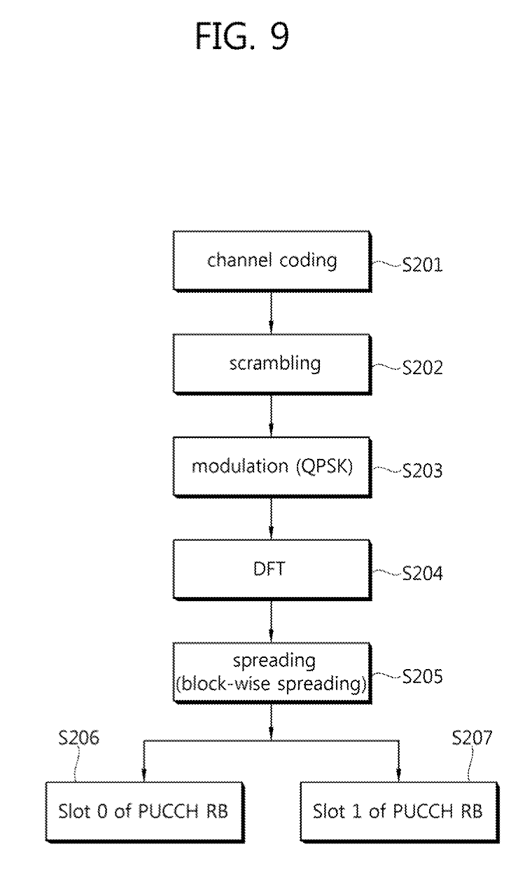

FIG. 9 shows a process of transmitting a signal by using a PUCCH format 3.

Referring to FIG. 9, channel coding is performed on a bit-stream consisting of an ACK/NACK information bit (step S201). An RM code may be used in the channel coding.

An encoding information bit generated as a result of channel coding can be rate-matched by considering a resource to be mapped and a modulation symbol order. For inter-cell interference (ICI) randomization with respect to the generated encoding information bit, cell-specific scrambling using a scrambling code corresponding to a cell ID or UE-specific scrambling using a scrambling code corresponding to a radio network temporary identifier (RNTI) can be applied (step S202).

The scrambled encoding information bit is modulated by the use of a modulator (step S203). A modulation symbol sequence consisting of a QPSK symbol configured by modulating the scrambled encoding information can be generated. The QPSK symbol may be a complex modulation symbol having a complex value.

With respect to QPSK symbols in each slot, discrete Fourier transform (DFT) for generating a single carrier waveform is performed in each slot (step S204).

With respect to the QPSK symbol subjected to DFT, block-wise spreading is performed in an SC-FDMA symbol level by using a spreading code determined through predetermined dynamic signaling or radio resource control (RRC) signaling (step S205). That is, a modulation symbol sequence is spread by using an orthogonal sequence to generate a spread sequence.

The spread sequence is mapped to a subcarrier in the resource block (steps S206 and S207). Thereafter, it is converted into a time-domain signal by using inverse fast Fourier transform (IFFT), is then attached with a CP, and is then transmitted via a radio frequency (RF) unit.

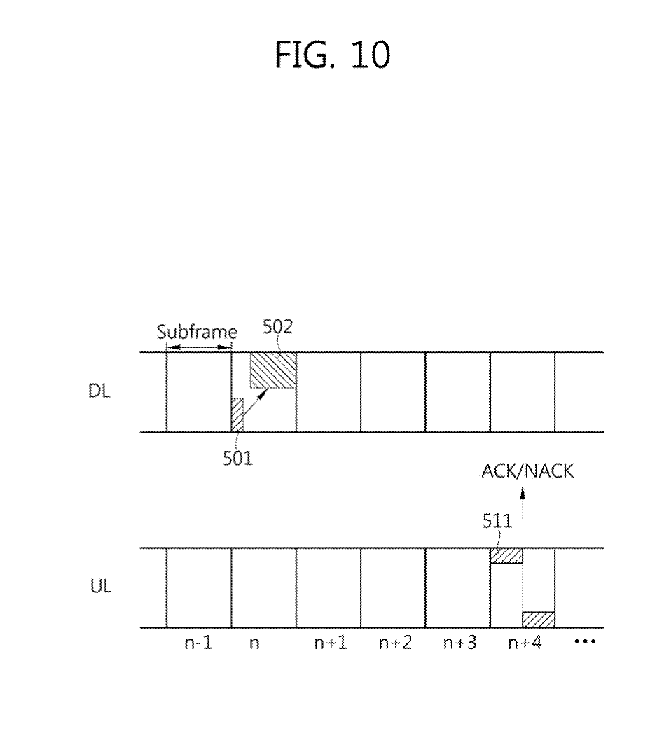

FIG. 10 shows an example of performing hybrid automatic repeat request (HARQ) in FDD.

By monitoring a PDCCH, a UE receives a DL resource allocation (or a DL grant) on a PDCCH 501 in an n^{th} DL subframe. The UE receives a DL transport block through a PDSCH 502 indicated by the DL resource allocation.

The UE transmits an ACK/NACK signal for the DL transport block on a PUCCH 511 in an (n+4)^{th} UL subframe. The ACK/NACK signal can be regarded as reception acknowledgement information for a DL transport block.

The ACK/NACK signal corresponds to an ACK signal when the DL transport block is successfully decoded, and corresponds to a NACK signal when the DL transport block fails in decoding. Upon receiving the NACK signal, a BS may retransmit the DL transport block until the ACK signal is received or until the number of retransmission attempts reaches its maximum number.

In 3GPP LTE, to configure a resource index for the PUCCH 511, the UE uses a resource allocation of the PDCCH 501. That is, a lowest CCE index (or an index of a first CCE) used for transmission of the PDCCH 501 is n_{CCE}, and the resource index is determined as n⁽¹⁾_{PUCCH}=n_{CCE}+N⁽¹⁾_{PUCCH}. As such, the PUCCH resource can be implicitly determined.

Hereinafter, a method of performing HARQ in TDD will be described. Unlike FDD, a DL subframe and a UL subframe which are temporally divided in a frequency band are used in the TDD. Table 4 below shows an exemplary structure of a radio frame that can be configured according to arrangement of the UL subframe and the DL subframe. In Table 4 below, ‘D’ denotes a DL subframe, ‘U’ denotes a UL subframe, and ‘S’ denotes a special subframe.

TABLE 4

| UL-DL | Subframe number | | | | | | | | | |
|---|---|---|---|---|---|---|---|---|---|---|
| configuration | 0 | 1 | 2 | 3 | 4 | 5 | 6 | 7 | 8 | 9 |
| 0 | D | S | U | U | U | D | S | U | U | U |
| 1 | D | S | U | U | D | D | S | U | U | D |
| 2 | D | S | U | D | D | D | S | U | D | D |
| 3 | D | S | U | U | U | D | D | D | D | D |
| 4 | D | S | U | U | D | D | D | D | D | D |
| 5 | D | S | U | D | D | D | D | D | D | D |
| 6 | D | S | U | U | U | D | S | U | U | D |

As shown in Table 4 above, there is a case where a ratio of the number of DL subframes and the number of UL subframes is not 1:1. In particular, if the number of DL subframes is greater than the number of UL subframes, there is a case where ACK/NACK for a data unit received in a plurality of DL subframes (i.e., M DL subframes, where M is a natural number greater than 2, for example, 2, 3, 4, or 9) needs to be transmitted in one UL subframe.

In this case, the UE can transmit one ACK/NACK for a plurality of PDSCHs, and the conventional method in use can be briefly classified into two methods as follows.

1. ACK/NACK Bundling

In the ACK/NACK bundling, if all of a plurality of PDSCHs received by a UE are successfully received, one ACK is transmitted through one PUCCH, and otherwise NACK is transmitted for all other cases.

2. Channel Selection Using the PUCCH Format 1b Based on PUCCH Resource Selection (Hereinafter, Simply Called Channel Selection).

In this method, a plurality of ACK/NACK signals are transmitted by allocating a plurality of PUCCH resources capable of transmitting ACK/NACK and by transmitting a modulation symbol in one PUCCH resource among the allocated plurality of PUCCH resources.

That is, in the channel selection, ACK/NACK contents are determined by combining a QPSK modulation symbol and a PUCCH resource used in ACK/NACK transmission. Table 5 below shows an example of the ACK/NACK contents determined according to 2-bit information indicated by the PUCCH resource and the modulation symbol in use.

TABLE 5

| HARQ-ACK(0), HARQ-ACK(1), HARQ- | | |
|---|---|---|
| ACK(2), HARQ-ACK(3) | n_{PUCCH}⁽¹⁾ | b(0), b(1) |
| ACK, ACK, ACK, ACK | n_{PUCCH,1}⁽¹⁾ | 1, 1 |
| ACK, ACK, ACK, NACK/DTX | n_{PUCCH,1}⁽¹⁾ | 1, 0 |
| NACK/DTX, NACK/DTX, NACK, DTX | n_{PUCCH,2}⁽¹⁾ | 1, 1 |
| ACK, ACK, NACK/DTX, ACK | n_{PUCCH,1}⁽¹⁾ | 1, 0 |
| NACK, DTX, DTX, DTX | n_{PUCCH,0}⁽¹⁾ | 1, 0 |
| ACK, ACK, NACK/DTX, NACK/DTX | n_{PUCCH,1}⁽¹⁾ | 1, 0 |
| ACK, NACK/DTX, ACK, ACK | n_{PUCCH,3}⁽¹⁾ | 0, 1 |
| NACK/DTX, NACK/DTX, NACK/DTX, | n_{PUCCH,3}⁽¹⁾ | 1, 1 |
| NACK | | |
| ACK, NACK/DTX, ACK, NACK/DTX | n_{PUCCH,2}⁽¹⁾ | 0, 1 |
| ACK, NACK/DTX, NACK/DTX, ACK | n_{PUCCH,0}⁽¹⁾ | 0, 1 |
| ACK, NACK/DTX, NACK/DTX, NACK/DTX | n_{PUCCH,0}⁽¹⁾ | 1, 1 |
| NACK/DTX, ACK, ACK, ACK | n_{PUCCH,3}⁽¹⁾ | 0, 1 |
| NACK/DTX, NACK, DTX, DTX | n_{PUCCH,1}⁽¹⁾ | 0, 0 |
| NACK/DTX, ACK, ACK, NACK/DTX | n_{PUCCH,2}⁽¹⁾ | 1, 0 |
| NACK/DTX, ACK, NACK/DTX, ACK | n_{PUCCH,3}⁽¹⁾ | 1, 0 |
| NACK/DTX, ACK, NACK/DTX, NACK/DTX | n_{PUCCH,1}⁽¹⁾ | 0, 1 |
| NACK/DTX, NACK/DTX, ACK, ACK | n_{PUCCH,3}⁽¹⁾ | 0, 1 |
| NACK/DTX, NACK/DTX, ACK, NACK/DTX | n_{PUCCH,2}⁽¹⁾ | 0, 0 |
| NACK/DTX, NACK/DTX, NACK/DTX, ACK | n_{PUCCH,3}⁽¹⁾ | 0, 0 |
| DTX, DTX, DTX, DTX | N/A | N/A |

In Table 5, HARQ-ACK(i) indicates a result of ACK/NACK for a data unit i (i=0, 1, 2, 3). The data unit may imply a CW, a transmission block, or a PDSCH. DTX indicates that a receiving end fails to detect a presence of the data unit. n⁽¹⁾_{PUCCH, x} indicates a PUCCH resource used in ACK/NACK transmission. In Table 5, x is any one of values 0, 1, 2, and 3. The UE transmits 2-bit (i.e., b(0) and b(1)) information identified by a QPSK modulation symbol in one PUCCH resource selected from a plurality of allocated PUCCH resources. Then, the BS can know whether each data unit is successfully received by using a combination of the QPSK modulation symbol and a PUCCH resource used for actual ACK/NACK transmission. For example, if the UE successfully receives 4 data units and then decodes the data units, the UE transmits 2 bits (i.e., (1, 1)) by using n⁽¹⁾_{PUCCH, 1}.

In the aforementioned ACK/NACK bundling or channel selection, the total number of PDSCHs for which ACK/NACK is transmitted by the UE is important. If the UE fails to receive some of the plurality of PDCCHs for scheduling a plurality of PDSCHs, an error occurs in the total number of PDSCHs for which the ACK/NACK is transmitted, and thus ACK/NACK may be transmitted erroneously. To correct this error, a TDD system transmits the PDCCH by including a downlink assignment index (DAI). The DAI reports a counting value by counting the number of PDCCHs for scheduling the PDSCHs.

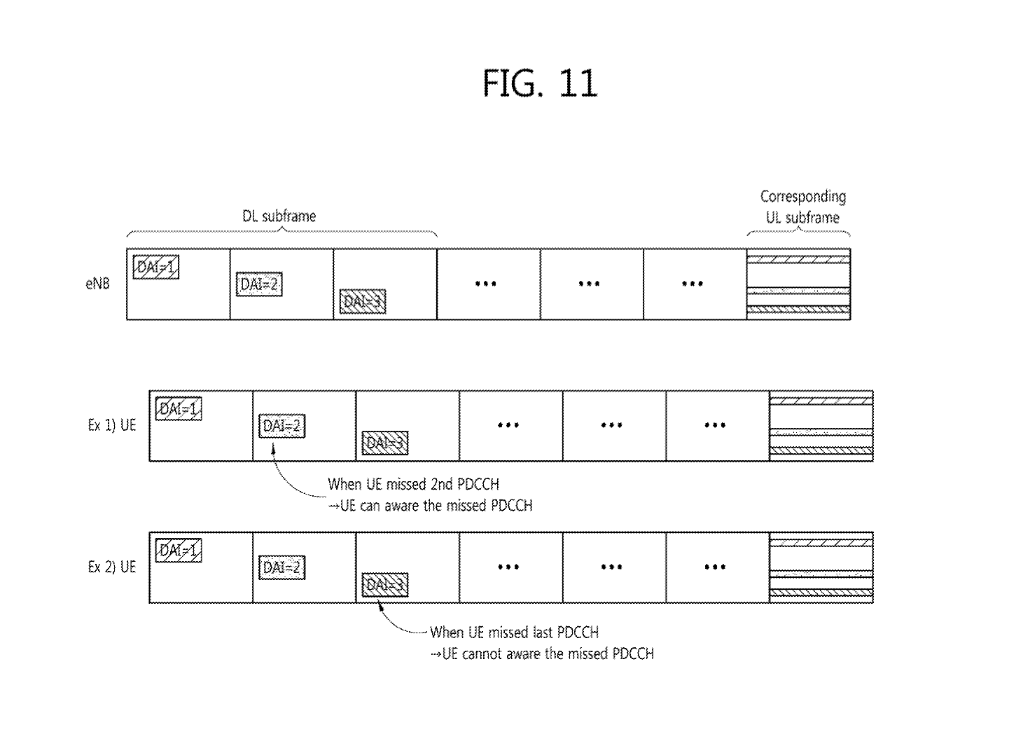

FIG. 11 shows an example of transmitting a DAI in a wireless communication system operating with TDD.

If one UL subframe is mapped to 3 DL subframes, indices are assigned sequentially to PDSCHs transmitted in a duration of the 3 DL subframes, and a DAI having a corresponding index as a counter value is transmitted by being carried on a PDCCH for scheduling the PDSCH. Then, by using a DAI field included in the PDCCH, a UE can know whether the previous PDCCHs are correctly received.

In a first example of FIG. 11, if the UE fails to receive a second PDCCH, a DAI of a third PDCCH is not equal to the number of PDCCHs received up to then, and thus it can be known that the second PDCCH is not successfully received.

In a second example of FIG. 11, if the UE fails to receive a last PDCCH, i.e., a third PDCCH, the UE cannot recognize an error since the number of PDCCHs received until the second PDCCH is received is equal to a DAI value. However, since the UE transmits ACK/NACK by using a PUCCH resource corresponding to DAI=2 rather than a PUCCH resource corresponding to DAI=3, a BS can know that the UE fails to receive the third PDCCH.

Now, a multiple-carrier system will be described.

A 3GPP LTE system supports a case in which a DL bandwidth and a UL bandwidth are differently configured under the premise that one component carrier (CC) is used. The 3GPP LTE system supports up to 20 MHz, and the UL bandwidth and the DL bandwidth may be different from each other. However, only one CC is supported in each of UL and DL cases.

Carrier aggregation (CA) (also referred to as spectrum aggregation or bandwidth aggregation) supports a plurality of CCs. For example, if 5 CCs are assigned as a granularity of a carrier unit having a bandwidth of 20 MHz, a bandwidth of up to 100 MHz can be supported.

A system band of a wireless communication system is divided into a plurality of carrier frequencies. Herein, the carrier frequency implies a center frequency of a cell. Hereinafter, the cell may imply a pair of a DL CC and a UL CC. Alternatively, the cell may also imply a combination of a DL CC and an optional UL CC.

In order to transmit and receive a transport block through a specific cell, the UE first has to complete configuration of the specific cell. Herein, the configuration implies a state of completely receiving system information required for data transmission and reception for the cell. For example, the configuration may include an overall procedure for receiving common physical layer parameters necessary for data transmission and reception, MAC layer parameters, or parameters necessary for a specific operation in an RRC layer.

The cell in a state of completing its configuration can exist in an activation or deactivation state. Herein, the activation implies that data transmission or reception is performed or is in a ready state. The UE can monitor or receive a control channel (i.e., PDCCH) and a data channel (i.e., PDSCH) of an activated cell in order to confirm a resource (e.g., frequency, time, etc.) allocated to the UE.

The deactivation implies that data transmission or reception is impossible and measurement or transmission/reception of minimum information is possible. The UE can receive system information (SI) required to receive a packet from a deactivated cell. On the other hand, in order to confirm the resource (e.g., frequency, time, etc.) allocated to the UE, the UE does not monitor or receive a control channel (i.e., PDCCH) and a data channel (i.e., PDSCH) of the deactivated cell.

A cell can be classified into a primary cell, a secondary cell, a serving cell, etc.

The primary cell implies a cell that operates at a primary frequency. Further, the primary cell implies a cell in which the UE performs an initial connection establishment procedure or a connection re-establishment procedure with respect to the BS or a cell indicated as the primary cell in a handover procedure.

The secondary cell implies a cell that operates at a secondary frequency. Once an RRC connection is established, the secondary cell is used to provide an additional radio resource.

The serving cell is configured with the primary cell in case of a UE of which carrier aggregation is not configured or which cannot provide the carrier aggregation. If the carrier aggregation is configured, the term ‘serving cell’ is used to indicate a set consisting of one or a plurality of cells among primary cells or all secondary cells.

A set of serving cells configured only for one UE may consist of only one primary cell, or may consist of one primary cell and at least one secondary cell.

A primary component carrier (PCC) denotes a CC corresponding to the primary cell. The PCC is a CC that establishes an initial connection (or RRC connection) with the BS among several CCs. The PCC serves for connection (or RRC connection) for signaling related to a plurality of CCs, and is a CC that manages UE context which is connection information related to the UE. In addition, the PCC establishes a connection with the UE, and thus always exists in an activation state when in an RRC connected mode. A DL CC corresponding to the primary cell is called a DL primary component carrier (DL PCC), and a UL CC corresponding to the primary cell is called a UL primary component carrier (UL PCC).

A secondary component carrier (SCC) implies a CC corresponding to the secondary cell. That is, the SCC is a CC allocated to the UE in addition to the PCC. The SCC is an extended carrier used by the UE for additional resource allocation or the like in addition to the PCC, and can operate either in an activation state or a deactivation state. A DL CC corresponding to the secondary cell is called a DL secondary CC (DL SCC), and a UL CC corresponding to the secondary cell is called a UL secondary CC (UL SCC).

The primary cell and the secondary cell have the following features.

First, the primary cell is used for PUCCH transmission. Second, the primary cell is always activated, whereas the secondary cell relates to a carrier which is activated/deactivated according to a specific condition. Third, when the primary cell experiences a radio link failure (RLF), RRC re-connection is triggered, whereas when the secondary cell experiences the RLF, the RRC re-connection is not triggered. Fourth, the primary cell can change by a handover procedure accompanied by a random access channel (RACH) procedure or security key modification. Fifth, non-access stratum (NAS) information is received through the primary cell. Sixth, the primary cell always consists of a pair of a DL PCC and a UL PCC. Seventh, for each UE, a different CC can be configured as the primary cell. Eighth, a procedure such as reconfiguration, adding, and removal of the primary cell can be performed by an RRC layer. When adding a new secondary cell, RRC signaling can be used for transmission of system information of a dedicated secondary cell.

Regarding a CC constructing a serving cell, a DL CC can construct one serving cell, or the DL CC can be connected to a UL CC to construct one serving cell. However, the serving cell is not constructed only with one UL CC.

Activation/deactivation of a CC is equivalent in concept to activation/deactivation of a serving cell. For example, if it is assumed that a serving cell 1 consists of a DL CC 1, activation of the serving cell 1 implies activation of the DL CC 1. If it is assumed that a serving cell 2 is configured by connecting a DL CC 2 and a UL CC 2, activation of the serving cell 2 implies activation of the DL CC 2 and the UL CC 2. In this sense, each CC can correspond to a cell.

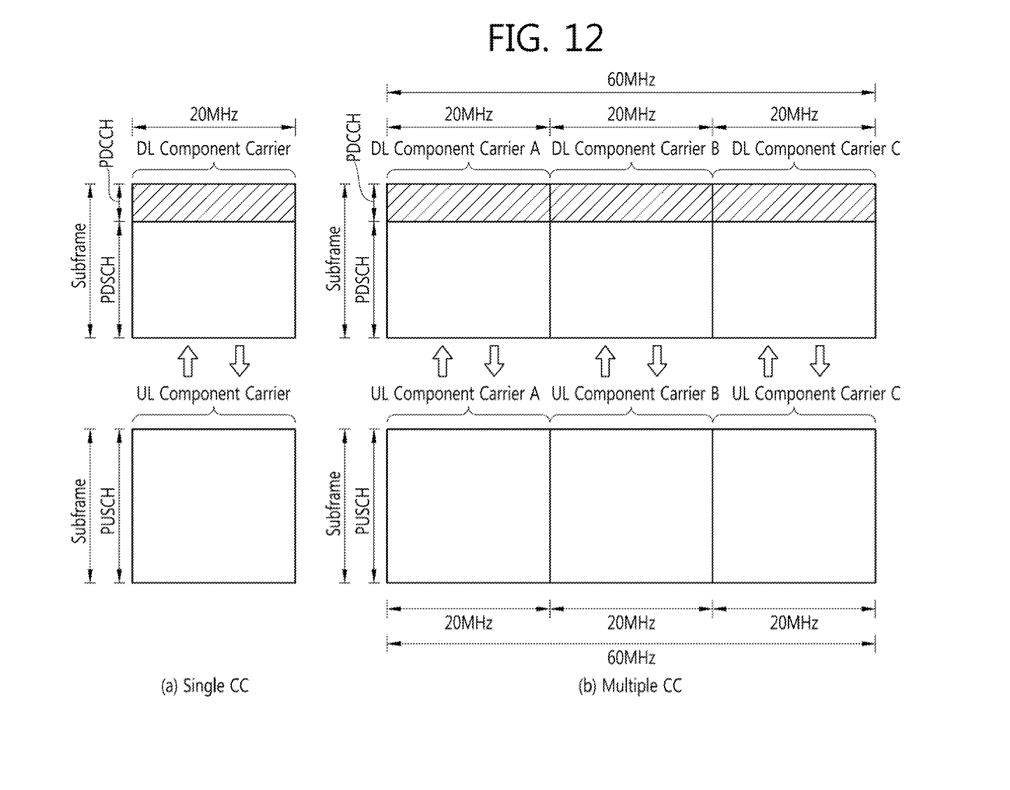

FIG. 12 shows an example of comparing a single-carrier system and a multiple-carrier system.

Referring to FIG. 12(a), only one carrier is supported for a UE in an uplink and a downlink in the single-carrier system. The carrier may have various bandwidths, but only one carrier is assigned to the UE. Meanwhile, multiple CCs, i.e., DL CCs A to C and UL CCs A to C, can be assigned to the UE in the multiple-carrier system of FIG. 12(b). For example, three 20 MHz CCs can be assigned to allocate a 60 MHz bandwidth to the UE. Although three DL CCs and three UL CCs are shown FIG. 12(b), the number of DL CCs and the number of UL CCs are not limited thereto. A PDCCH and a PDSCH are independently transmitted in each DL CC. A PUCCH and a PUSCH are independently transmitted in each UL CC. Since three DL CC-UL CC pairs are defined, it can be said that the UE receives a service from three serving cells.

The UE can monitor the PDCCH in a plurality of DL CCs, and can receive a DL transport block simultaneously via the plurality of DL CCs. The UE can transmit a plurality of UL transport blocks simultaneously via a plurality of UL CCs.

Two CC scheduling methods are possible in the multiple-carrier system.

First, a PDCCH-PDSCH pair is transmitted in one CC. This CC is called self-scheduling. In addition, this implies that a UL CC in which a PUSCH is transmitted is a CC linked to a DL CC in which a corresponding PDCCH is transmitted. That is, the PDCCH allocates a PDSCH resource on the same CC, or allocates a PUSCH resource on a linked UL CC.

Second, a DL CC in which the PDSCH is transmitted or a UL CC in which the PUSCH is transmitted is determined irrespective of a DL CC in which the PDCCH is transmitted. That is, the PDCCH and the PDSCH are transmitted in different DL CCs, or the PUSCH is transmitted through a UL CC which is not linked to the DL CC in which the PDSCH is transmitted. This is called cross-carrier scheduling. A CC in which the PDCCH is transmitted is called a PDCCH carrier, a monitoring carrier, or a scheduling carrier. A CC in which the PDSCH/PUSCH is transmitted is called a PDSCH/PUSCH carrier or a scheduled carrier.

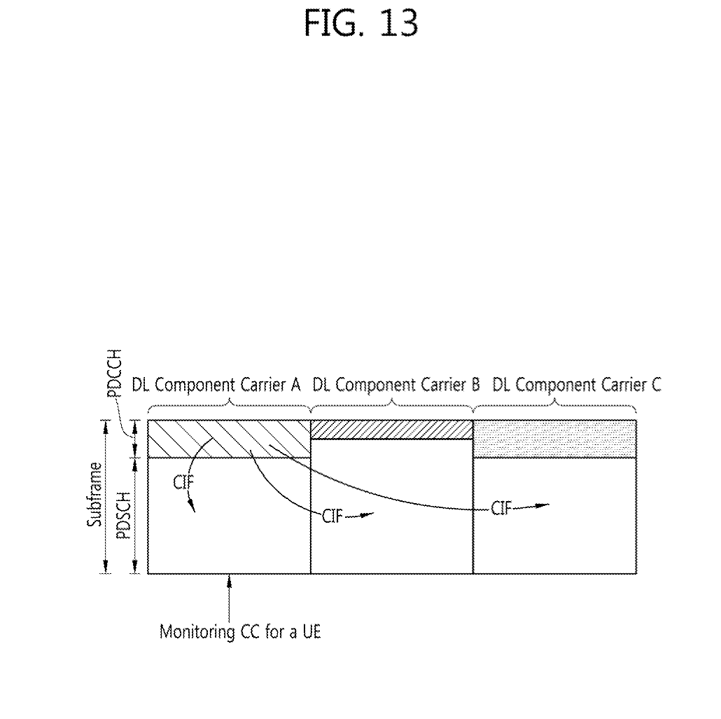

FIG. 13 shows an example of cross-carrier scheduling.

Referring to FIG. 13, three DL CCs (i.e., DL CC A, DL CC B, and DL CC C) are configured to a UE. Among them, the DL CC A is a monitoring CC in which the UE monitors a PDCCH. The UE receives downlink control information (DCI) for the DL CC A, the DL CC B, and the DL CC C in a PDCCH of the DL CC A. Since a CIF is included in the DCI, the UE can identify to which DL CC the DCI belongs. The monitoring CC may be a DL PCC. Such a monitoring CC can be configured in a UE-specific manner or a UE group-specific manner.

When the multiple-carrier system such as LTE-A operates with TDD, a plurality of serving cells, i.e., a plurality of CCs, can be assigned to the UE. The UE can receive a plurality of PDSCHs through a plurality of CCs, and can transmit ACK/NACK for the plurality of PDSCHs through a specific UL CC. In this case, an information amount of ACK/NACK that must be transmitted simultaneously in one UL subframe is increased in proportion to the number of aggregated DL CCs. The transmissible ACK/NACK information amount may be limited according to a UL channel situation and a capacity limitation of a PUCCH format used for ACK/NACK transmission. In one method for solving this problem, ACK/NACK is transmitted by being bundled without having to transmit it individually for each data unit (e.g., a CW or a PDSCH). For example, if the UE receives a CW 0 and a CW 1 in a DL subframe 1, instead of transmitting ACK/NACK information for each CW, bundling is performed in such a manner that ACK is transmitted when both of the CW 0 and the CW 1 are successfully decoded and otherwise NACK/DTX is transmitted.

The present invention describes how to transmit ACK/NACK in a multiple-carrier system when applying a mechanism of using a PUCCH format 3 based on block spreading and a channel selection mechanism based on PUCCH resource selection as a method of transmitting ACK/NACK from a UE to a BS. Although a case where one ACK/NACK indicates whether one CW is successfully received or not is exemplified hereinafter, the present invention is not limited thereto. That is, one ACK/NACK may be for a PDCCH which requests an ACK/NACK response. The PDCCH may be a semi-persistent scheduling (SPS) PDCCH.

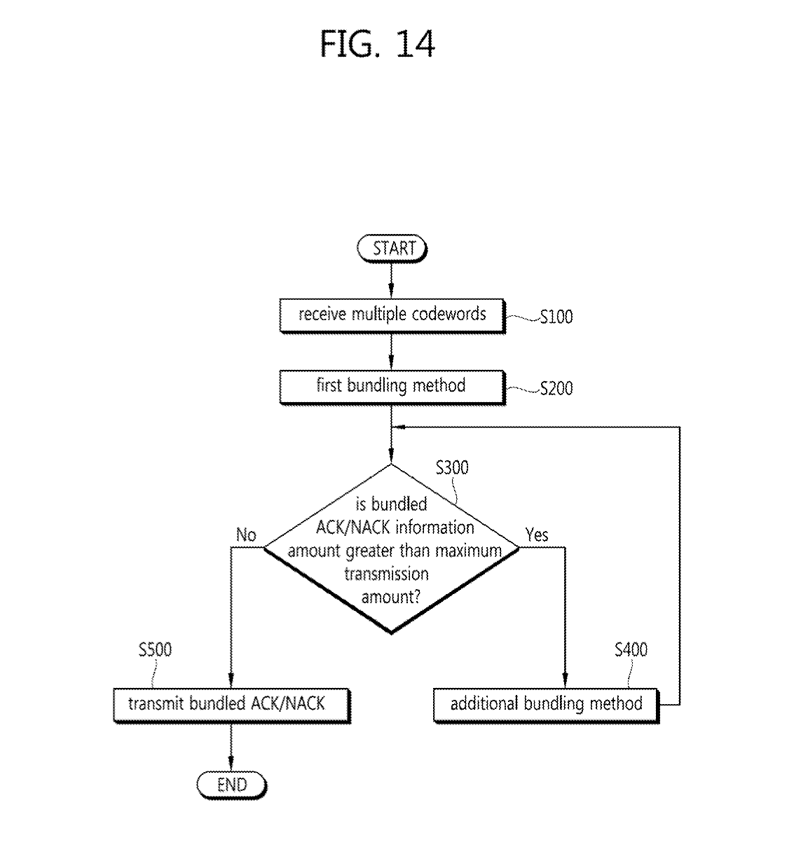

FIG. 14 shows an ACK/NACK transmission method according to an embodiment of the present invention.

Referring to FIG. 14, a UE receives a plurality of CWs (step S100). In TDD, the UE can receive the plurality of CWs through M DL subframes (where M is a natural number) in one radio frame. One or two CWs can be received in each DL subframe.

The UE generates ACK/NACK information according to whether each of the plurality of received CWs is successfully received, and thereafter applies a first bundling method to the ACK/NACK information (step 200). The first bundling method may be an ‘intra-CC spatial bundling method’. The intra-CC spatial bundling method is a method of bundling a plurality of CWs received in one DL subframe within a specific CC.

For example, assume that a DL CC 0, a DL CC 1, and a DL CC 2 are assigned to the UE. In this case, the DL CC 1 may be set to a multiple-codeword (CW) transmission (Tx) mode (i.e., MIMO mode). Then, the UE can receive two CWs in each DL subframe of the DL CC 1. The UE can generate 2-bit ACK/NACK information for the two CWs received in one DL subframe, and thereafter can generate 1-bit ACK/NACK information by performing an AND operation on each bit. That is, if both of the two CWs are successfully received, ACK is generated, and otherwise NACK is generated. When bundling is performed in this manner, it is called the intra-CC spatial bundling. The UE can always apply the first bundling method. Alternatively, the UE can apply the first bundling method only when the ACK/NACK information amount is greater than a maximum transmission amount of an ACK/NACK transmission method.

The UE determines whether an information amount of ACK/NACK bundled by using the first bundling method is greater than the maximum transmission amount (step S300). For example, in case of LTE-A, the maximum number of transmissible ACK/NACK bits may be 4 in a channel selection mechanism based on PUCCH resource selection. The UE determines whether the number of bundled ACK/NACK bits is greater than 4.

Alternatively, if ACK/NACK is transmitted by using the PUCCH format 3, the maximum number of transmissible ACK/NACK bits may be 20. In this case, the UE determines whether the number of the bundled ACK/NACK bits is greater than 20.

If the information amount of the bundled ACK/NACK is greater than the maximum transmission amount, an additional bundling method is applied (step S400). The additional bundling method may be an inter-CC frequency domain bundling method, a time domain bundling method, a combination of the two bundling methods, etc.

The inter-CC frequency domain bundling method is a method of bundling ACK/NACK for a plurality of CWs received in the same subframe of different CCs assigned to the UE. For example, assume a case in which the DL CC 0 and the DL CC 1 are assigned to the UE. A BS may transmit two CWs in a DL subframe N of the DL CC 0 and one CW in a DL subframe N of the DL CC 1. In this case, the UE may generate 1-bit ACK/NACK information by performing bundling on 3-bit ACK/NACK information for the three CWs. That is, ACK is generated when all of the three CWs are successfully received, and otherwise NACK is generated. Alternatively, ACK/NACK information used to perform intra-CC spatial bundling on two CWs in a subframe N of the DL CC 0 may be bundled with ACK/NACK information for one CW in a DL subframe N of the DL CC 1. The inter-CC frequency domain bundling method may be applied to all DL subframes or may be applied to only some DL subframes according to a determined rule.

In the time domain bundling, the UE performs bundling on ACK/NACK for a data unit received in different DL subframes. For example, assume that the DL CC 0 and the DL CC 1 are assigned to the UE, and the DL CC 0 is in a MIMO mode in which two CWs can be received and the DL CC 1 is in a single-CW Tx mode in which only one CW can be received. If the UE successfully receives a CW 0 and a CW 1 in a DL subframe 1 of the DL CC 0 and successfully receives only the CW 0 in a DL subframe 2 of the DL CC 0, the UE may generate ACK for the CW 0 and NACK for the CW 1. That is, ACK/NACK bundling is performed for each CW received in a different DL subframe.

Alternatively, in the above example, the UE may generate ACK for the DL subframe 1 of the DL CC 0 and generate NACK for the DL subframe 2, and thereafter may finally generate NACK for the DL subframes 1 and 2. This method corresponds to a case where the intra-CC spatial bundling is first applied to each DL subframe and thereafter the time domain bundling is applied.

A detailed example of applying the aforementioned first bundling method and additional bundling method will be described hereinafter with reference to the accompanying drawings.

Whether an information amount of ACK/NACK additionally bundled by the additional bundling method is greater than the maximum transmission amount is determined, and if the information amount is still greater than the maximum transmission amount, the additional bundling method is applied again (step S400).

If the information amount of ACK/NACK bundled by the additional bundling method is less than or equal to the maximum transmission amount, the bundled ACK/NACK is transmitted (step S500). In this case, it is possible to use the PUCCH format 3 based on block spreading or the channel selection mechanism based on PUCCH resource selection.

Now, a method of bundling ACK/NACK information according to a method of transmitting ACK/NACK by a UE will be described.

1. ACK/NACK bundling method in case of using a channel selection mechanism based on PUCCH resource selection in TDD (hereinafter, simply called a channel selection mechanism).

An LTE-A system can transmit up to 4-bit ACK/NACK by using the channel selection mechanism. The ACK/NACK can be transmitted separately one by one per CW, and thus if the number of CWs exceeds 4, the CWs need to be grouped to bundle ACK/NACK for each CW group.

[Method 1-1]

Method for applying intra-CC spatial bundling always if a corresponding CC is set to a MIMO mode, and for applying inter-CC frequency domain bundling if the number of bits of intra-CC spatial bundled ACK/NACK exceeds 4.

1) If a plurality of CWs exist in a PDSCH transmitted in one DL subframe in one CC, ACK/NACK for the plurality of CWs is bundled. As described above, this is called intra-CC spatial bundling. The intra-CC spatial bundling can be always applied to a CC assigned to be able to transmit a plurality of CWs, that is, a CC which is set to a MIMO mode.

2) If the number of bits of ACK/NACK to which the intra-CC spatial bundling is applied exceeds 4, inter-CC frequency domain bundling is additionally applied. That is, CC-dimension spatial bundling is additionally performed. In this case, the inter-CC frequency domain bundling can be applied to all subframes, or can be applied until the number of bits of ACK/NACK becomes 4 according to a predetermined rule.

[Method 1-2]

This is a method in which the aforementioned Method 1-1 is applied only when the number of CWs for which ACK/NACK is transmitted exceeds 4. Method 1-2 is a method of imposing an additional constraint on the Method 1-1. That is, the intra-CC spatial bundling is always applied in the Method 1-1 when a plurality of CWs are transmitted in a PDSCH transmitted in one CC, whereas in the Method 1-2, the intra-CC spatial bundling is applied only when the number of CWs for which ACK/NACK transmitted in a UL subframe is transmitted exceeds 4, and the inter-CC frequency domain bundling is applied when the ACK/NACK information amount exceeds 4 bits even after applying the intra-CC spatial bundling.

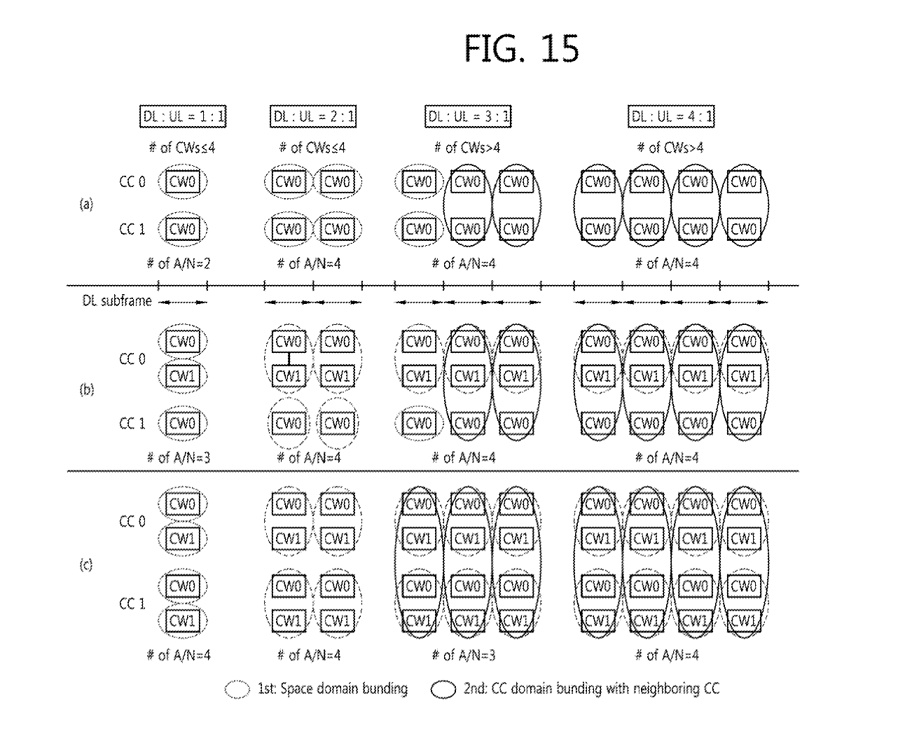

FIG. 15 shows an example of the aforementioned Methods 1-1 and 1-2. In FIG. 15, ‘DL:UL’ denotes a ratio of a DL subframe and a UL subframe included in one radio frame. For convenience, a DL CC is expressed by a CC in FIG. 15 (this is also equally applied hereinafter).

In FIG. 15, three cases (a), (b), and (c) are exemplified. In FIG. 15(a), a CC 0 and a CC 1 are set to a single-CW Tx mode. Therefore, intra-CC spatial bundling is not applied. For example, if a DL:UL ratio is 3:1, the total number of CWs for which ACK/NACK is transmitted is 6 in the CC 0 and the CC 1. In this case, a CW 0 of the CC 0 and a CW 0 of the CC 1 for a second DL subframe are subjected to inter-CC frequency domain bundling, and a CW 0 of a CC 0 and a CW 0 of a CC 1 for a third DL subframe are subjected to inter-CC frequency domain bundling. As a result, the total number of bits of ACK/NACK transmitted in the UL subframe is 4.

Referring to FIG. 15(b), a CC 0 is set to a MIMO Tx mode in which two CWs are transmitted in a PDSCH. If a DL:UL ratio is 3:1, a CW 0 and a CW 1 for a CC 0 are first bundled by using intra-CC spatial bundling. Then, the total number of ACK/NACK bits for a CC 0 and a CC 1 with respect to a first DL subframe, a second DL subframe, and a third DL subframe is 6. Since the number of ACK/NACK bits exceeds 4, inter-CC frequency domain bundling is applied. For example, an ACK/NACK bit in which a CW 0 and a CW 1 of the CC 0 in the second DL subframe are subjected to intra-CC spatial bundling is bundled with an ACK/NACK bit for a CW 0 of the CC 1 by using inter-CC frequency domain bundling. The same is also true for the third DL subframe. In this manner, the UE can generate 4-bit ACK/NACK.

Referring to FIG. 15(c), a CC 0 and a CC 1 are both set to a MIMO mode. If a DL:UL ratio is 3:1, a UE first performs intra-CC spatial bundling for each CC. Then, 6-bit ACK/NACK information is generated. The UE bundles an ACK/NACK bit obtained by performing intra-CC spatial bundling on a CW 0 and a CW 1 of a CC 0 in a first DL subframe with an ACK/NACK bit in which a CW 0 and a CW 1 of a CC 1 are subjected to intra-CC spatial bundling by using inter-CC frequency domain bundling. In this manner, bundling is also performed on second and third DL subframes, and thus the UE can generate 3-bit ACK/NACK.

A PUCCH resource allocated for ACK/NACK transmission in the aforementioned Method 1-1 and Method 1-2 can be determined by using an implicit method. That is, a PUCCH resource corresponding to a resource index of a PDCCH for scheduling a PDSCH transmitted via each CC is allocated for ACK/NACK transmission, and thereafter a modulation symbol is transmitted by selecting one PUCCH resource according to ACK/NACK for the PDSCH. Such an implicit method has an advantage in that a resource allocation method of conventional LTE Rel-8 can be reutilized.

The PUCCH resource allocated for ACK/NACK transmission can also be indicted by using an explicit method. For example, a BS can explicitly report the PUCCH resource by using a higher layer signal such as an RRC signal. In addition, the BS can additionally transmit an ACK/NACK resource indicator (ARI) through the PDCCH and thus can provide an offset value to the PUCCH resource indicated by the RRC signal.

Alternatively, for some CCs, the PUCCH resource for ACK/NACK transmission can be allocated by using the implicit method, and for the remaining CCs, the PUCCH resource for ACK/NACK transmission can be allocated by using the explicit method. The number of PUCCH resources indicated by using the explicit method may be equal to the number of DL subframes mapped to one UL subframe. For example, if a DL:UL ratio of the CC 0 is 4:1 and the PUCCH resource is indicated by using the explicit method, the number of PUCCH resources to be allocated explicitly may be 4.

An example of applying intra-CC spatial bundling and inter-CC frequency domain bundling is described above in the Method 1-1 and the Method 1-2. Hereinafter, an example of applying intra-CC spatial bundling and time domain bundling will be described.

[Method 1-3]

Method of applying intra-CC spatial bundling always and thereafter applying time domain bundling.

Method 1-3 always applies intra-CC spatial bundling if a corresponding CC is set to a MIMO mode, and applies time domain bundling if the number of bits of ACK/NACK subjected to the intra-CC spatial bundling exceeds 4. As described above, the time domain bundling is for performing ACK/NACK bundling on a CW of consecutive DL subframes in one CC. If the number of ACK/NACK bits exceeds 4 even after performing the time domain bundling, bundling can be performed on a DL subframe group.

[Method 1-4]

Method for first applying intra-CC spatial bundling if the number of CWs for which ACK/NACK is transmitted exceeds 4, and for applying time domain bundling on consecutive DL subframes.

That is, Method 1-4 is a method of adding an additional execution condition to the Method 1-3. Whereas the Method 1-3 always applies intra-CC spatial bundling when a CC is set to a MIMO mode, the Method 1-4 applies intra-CC spatial bundling and time domain bundling only when the number of CWs for which ACK/NACK to be transmitted in a UL subframe is transmitted exceeds 4.

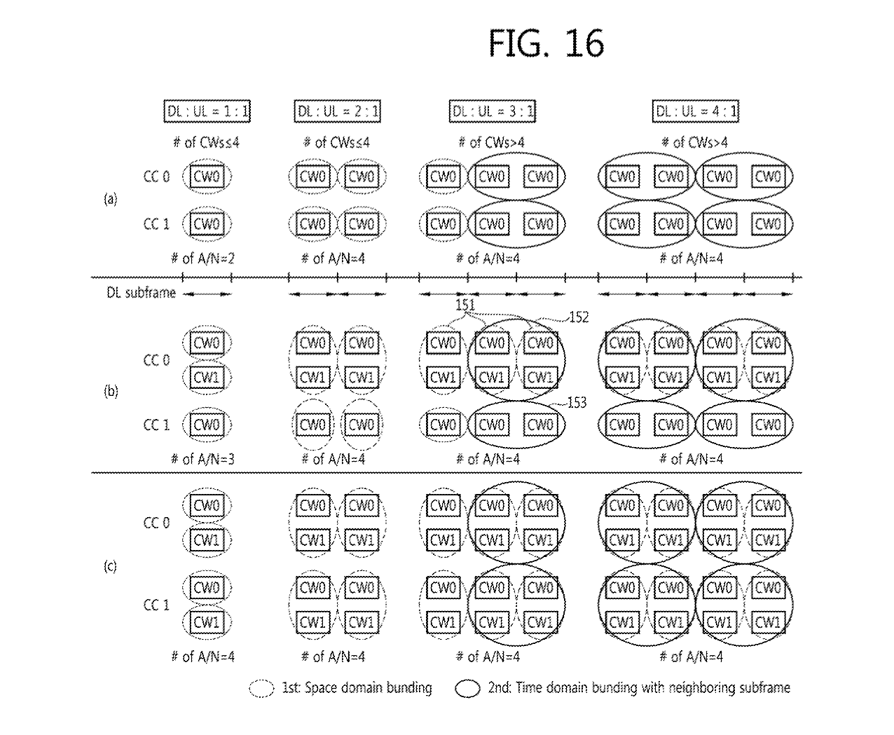

FIG. 16 shows an example of the aforementioned Methods 1-3 and 1-4.

In FIG. 16(a), a CC 0 and a CC 1 are set to a single-CW TX mode. Therefore, intra-CC spatial bundling is not applied. If the number of CWs for which ACK/NACK is transmitted exceeds 4, time domain bundling is applied. For example, if a DL:UL ratio is 3:1, the total number of CWs for which ACK/NACK to be transmitted in a UL subframe is transmitted is 6. In this case, for the CC 0, ACK/NACK for a CW 0 of a second subframe and a CW 0 of a third DL subframe are bundled in a time domain. Likewise, for the CC 1, ACK/NACK for a CW 0 of a second subframe and a CW 0 of a third DL subframe are bundled in the time domain. As a result, the total number of bits of ACK/NACK transmitted in the UL subframe is 4.

Referring to FIG. 16(b), a CC 0 is set to a MIMO Tx mode in which two CWs are transmitted in a PDSCH. If a DL:UL ratio is 3:1, a CW 0 and a CW 1 for the CC 0 are first bundled by using intra-CC spatial bundling (see 151). Then, the total number of bits of ACK/NACK for first, second, and third DL subframes is 6 in the CC 0 and the CC 1. Since the number of ACK/NACK bits exceeds 4, time domain bundling is applied. For example, the time domain bundling is performed on the second and third DL subframes in the CC 0 and the CC 1 (see 151 and 152). In this manner, the UE can generate 4-bit ACK/NACK.

Referring to FIG. 16(c), a CC 0 and a CC 1 are both set to a MIMO mode. If a DL:UL ratio is 3:1, a UE first performs intra-CC spatial bundling for each CC. Then, 6-bit ACK/NACK information is generated. The UE can generate 4-bit ACK/NACK by performing time domain bundling for the second and third DL subframes.

In the aforementioned Method 1-3 and Method 1-4, a PUCCH resource allocated for ACK/NACK transmission can be indicated by using an implicit method and an explicit method. Alternatively, for some CCs, the PUCCH resource for ACK/NACK transmission can be allocated by using the implicit method, and for the remaining CCs, the PUCCH resource for ACK/NACK transmission can be allocated by using the explicit method. The number of PUCCH resources indicated by using the explicit method may be equal to the number of DL subframe groups to be bundled and mapped to one UL subframe. For example, if a DL:UL ratio of a CC 0 is 4:1 and two DL subframes are bundled in a time domain, the number of DL subframe groups to be bundled is 2. In this case, if the PUCCH resource is indicated by using the explicit method, two explicit PUCCH resources are allocated. Therefore, the number of PUCCH resources to be allocated for ACK/NACK transmission can be decreased in comparison with the Method 1-1 and the Method 1-2.

2. ACK/NACK bundling method in case of transmitting ACK/NACK by using PUCCH format 3 in TDD.

A PUCCH format 3 is employed in an LTE-A system. The PUCCH format 3 can transmit up to 20-bit ACK/NACK. One bit can be assigned per CW in ACK/NACK. If the total number of CWs of DL subframes mapped to one UL subframe exceeds 20, ACK/NACK bundling can be used. Alternatively, if the number of transmissible bits in the PUCCH format 3 is limited to be less than or equal to 20 according to a channel situation, ACK/NACK bundling can be used even if the total number of CWs does not exceed 20.

[Method 2-1]

Method for always applying intra-CC spatial bundling if a CC assigned to a UE is in a MIMO Tx mode, and for applying inter-CC frequency domain bundling if the number of bits of ACK/NACK subjected to intra-CC spatial bundling exceeds a maximum transmission amount.

The inter-CC frequency domain bundling may be applied for all subframes or may be applied only for some subframes according to a predetermined rule. Alternatively, the inter-CC frequency domain bundling may be applied only for some CCs. For example, the inter-CC frequency domain bundling may not be applied in a PCC, and may be applied in an SCC according to a carrier indication field (CIF) value.

[Method 2-2]

Method for applying intra-CC spatial bundling only if the number of CWs for which ACK/NACK to be transmitted in a UL subframe exceeds a specific value, and otherwise for applying inter-CC frequency domain bundling. The specific value may be 20 when the PUCCH format 3 is applied. It is assumed hereinafter that the maximum number of ACK/NACK bits that can be transmitted using the PUCCH format 3 is X. Although X may be 20, the present invention is not limited thereto.

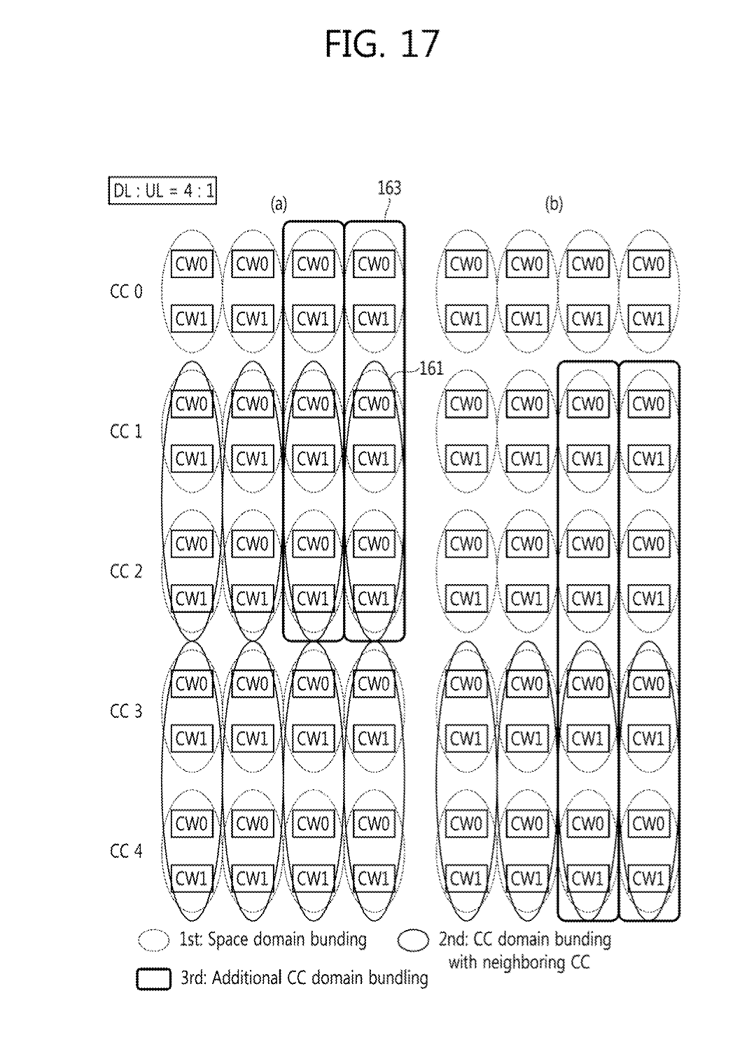

FIG. 17 shows an example of the aforementioned Methods 2-1 and 2-2. It is assumed in FIG. 17 that ‘DL:UL’ is 4:1. A CC 0 to a CC 4 are all set to a MIMO mode.

In FIGS. 17(a) and (b), intra-CC spatial bundling is applied to each CC. If an information amount of ACK/NACK subjected to intra-CC spatial bundling is greater than the X bits, inter-CC frequency domain bundling is applied (see 161). The inter-CC frequency domain bundling may be performed for two CCs having consecutive CC indices (i.e., CIFs). Alternatively, the inter-CC frequency domain bundling may be performed only for a plurality of SCCs except for a PCC. If the ACK/NACK information amount still exceeds the X bits even after performing the inter-CC frequency domain bundling, inter-CC frequency domain bundling may be performed on a CC group (see 163). A bundled ACK/NACK bit-stream generated by using such a method can be transmitted by using the PUCCH format 3.

[Method 2-3]

Method for applying intra-CC spatial bundling always and thereafter applying time domain bundling, if a CC assigned to a UE is set to a MIMO mode.

The time domain bundling can be performed only when an information amount of ACK/NACK generated as a result of performing intra-CC spatial bundling exceeds X bits of an information amount that can be transmitted by using the PUCCH format 3.

The time domain bundling can be performed for N consecutive DL subframes (where N is a natural number greater than or equal to 2). In this case, the time domain bundling can be performed sequentially until the bundled ACK/NACK information amount is less than or equal to X bits which is the maximum transmission amount of ACK/NACK of the PUCCH format 3. For example, assume that a DL:UL ratio is 4:1. In this case, the UE can receive CWs in DL subframes 0 to 3 in a CC 0 to a CC 4. In this case, if the ACK/NACK information amount exceeds X bits even after time domain bundling is performed for a DL subframe 2 and a DL subframe 3, time domain bundling can be performed for a DL subframe 0 and a DL subframe 1.

In addition, the time domain bundling may be performed for all CCs assigned to the UE or for only some CCs. For example, the time domain bundling may be applied to an SCC and a PCC, in that order.

[Method 2-4]

Method 2-4 is a method for applying the aforementioned Method 2-3 only when the number of CWs for which ACK/NACK is transmitted exceeds X.

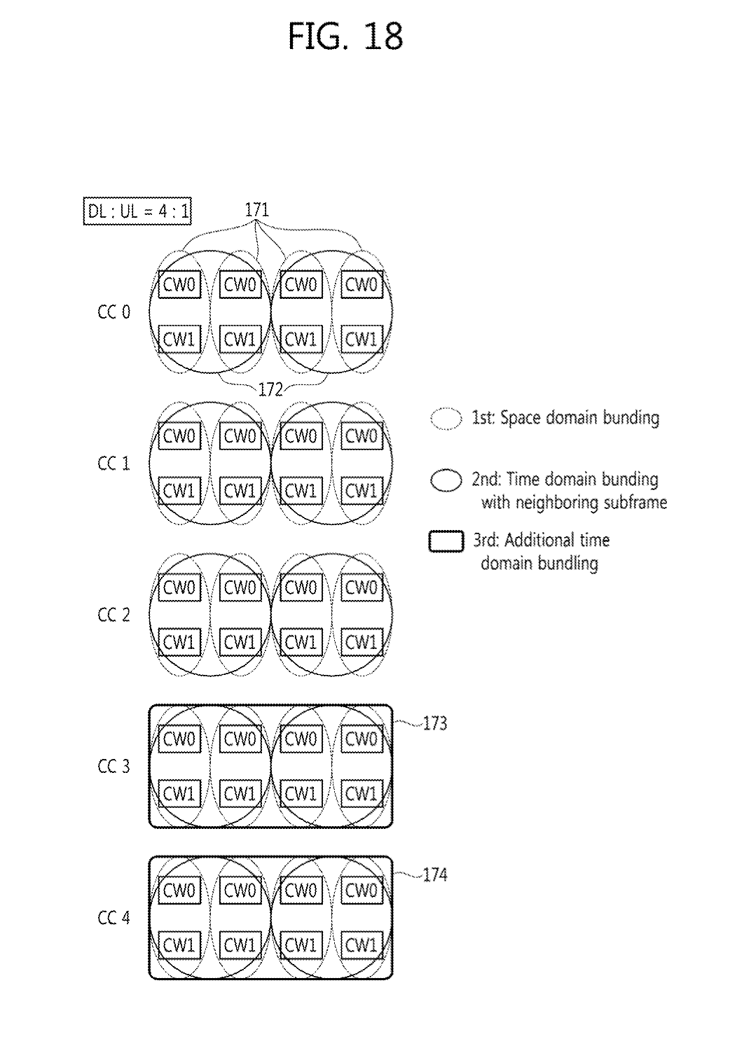

FIG. 18 shows an example of the aforementioned Methods 2-3 and 2-4. In FIG. 18, it is assumed that ‘DL:UL’ is 4:1. A CC 0 to a CC 4 are both set to a MIMO mode.

A UE first applies intra-CC spatial bundling in all CCs (see 171). An information amount of ACK/NACK generated by the intra-CC spatial bundling is compared with a maximum transmission amount, i.e., X bits, and if the information amount is greater than or equal to the X bits, time domain bundling is performed (see 172). The time domain bundling can be additionally performed until the information amount of the bundled ACK/NACK is less than or equal to the X bits (see 173 and 174).

[Method 2-5]

A UE may always apply intra-CC spatial bundling if a plurality of CWs are received since a CC is set to a MIMO mode. As a result, if the number of bits of bundled ACK/NACK exceeds a maximum transmission amount of the PUCCH format 3, the UE may additionally perform bundling on a bundling group signaled using RRC. Herein, the bundling group can be designated with a plurality of CCs in a CC dimension and a plurality of subframes in a time dimension. The Method 2-5 can be applied only when the number of CWs for which ACK/NACK is transmitted exceeds the maximum transmission amount of the PUCCH format 3.

In the aforementioned Methods 1-1 to 2-5, when applying the inter-CC frequency domain bundling and the time domain bundling, there may be a case where a UE fails to receive some of PDCCHs transmitted by a BS. In this case, the UE may erroneously recognize the number of CWs for which ACK/NACK bundling is performed. To avoid such an error, the BS transmits the PDCCH by including a downlink assignment index (DAI). In the conventional TDD, ACK is transmitted by using a PUCCH resource corresponding to the last PDCCH received by the UE, and thus the BS can indirectly know the last PDCCH received by the UE. However, such a method cannot be used in the aforementioned Methods 1-1 to 2-5. Therefore, to avoid occurrence of the error, the total number of PDCCHs for scheduling a PDSCH mapped to a UL subframe or the total number of PDSCHs mapped to the UL subframe may be reported to the DAI instead of a counter value. By using the DAI, the UE can know the number of PDCCHs to be received or the number of PDSCHs, thereby being able to avoid an error which occurs in ACK/NACK bundling.

When time domain bundling is performed for two consecutive DL subframes as shown in the Method 1-3, the Method 1-4, the Method 2-3, and the Method 2-4, the DAI may report the counter value by using only 1-bit information. Since the conventional DAI consists of 2 bits, the last one bit can be used as an indicator indicating whether it is a last PDCCH. Alternatively, the remaining one bit may be used for other purposes such as an ARI.

In the aforementioned methods, the time domain bundling is not necessarily performed after performing intra-CC spatial bundling. That is, the time domain bundling may be performed per CW without performing the intra-CC spatial bundling.

In addition, if the time domain bundling is performed for two DL subframes, the 2-bit DAI can be used for the purpose of reporting the total sum per CW. Then, a DAI value for a CW 0 may be 1 or 2, and a DAI value for a CW 1 may be any one of 0, 1, and 2. Since there is a case where the CW 1 is not transmitted, the DAI for the CW 1 may have a value of ‘0’. If a 1-bit DAI is used per CW, a 1-bit DAI for the CW 1 indicates 1 or 2, and a DAI for the CW 1 indicates (0,2) or 1. For example, if the 1-bit DAI value is 0, it may indicate that the number of CWs 1 is 1 or 2, and if the 1-bit DAI value is 1, it may indicate the number of CWs 1 is 1. In this case, since whether the number of CWs 1 is 0 or 2 can be identified in a scheduling process, overlapping mapping may be allowed.

Alternatively, the DAI can report the total number of CWs for two DL subframes to be subjected to time domain bundling in one CC.

If only the intra-CC spatial bundling is used, the DAI can be used for other purposes since it is not necessary to report a counter value or a total number. For example, the DAI can be used for the purpose of an ARI.

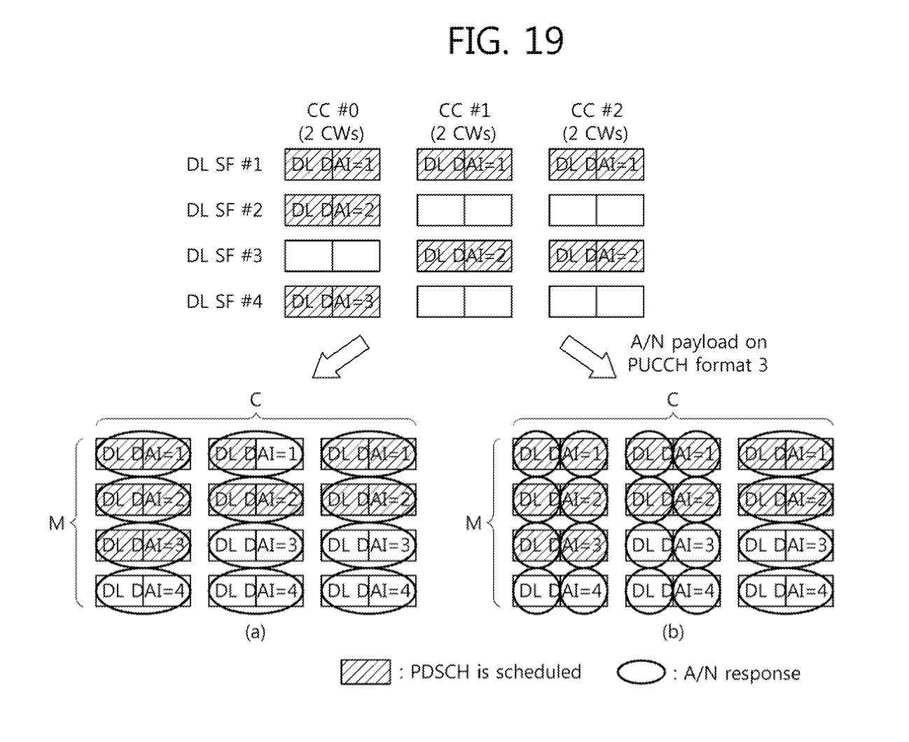

FIG. 19 shows an example of applying the conventional method and the present invention in case of transmitting ACK/NACK by using a PUCCH format 3.

Referring to FIG. 19, three CCs, i.e., a CC #0, a CC #1, and a CC #2, can be assigned to a UE via a DL CC. Each CC is set to a MIMO mode. Assume that ACK/NACK is transmitted in one UL subframe with respect to CWs received in 4 DL subframes. Then, the UE can receive up to 24 CWs in DL subframes #1 to #4 of the CC #0 to the CC #2.

In this situation, the UE can receive only 14 CWs in practice in the DL subframes #1 to #4 of the CC #0 to the CC #2. In this case, the conventional method transmits 12-bit ACK/NACK through the PUCCH format 3 by applying the intra-CC spatial bundling as shown in FIG. 19(a).

On the other hand, the present invention sequentially applies the intra-CC spatial bundling to ACK/NACK as shown in FIG. 19(b), and the intra-CC spatial bundling is no longer performed when the bundled ACK/NACK becomes 20 bits. For example, if the intra-CC spatial bundling is first applied to an SCC (i.e., CC #2) and the bundled ACK/NACK becomes 20 bits, then the intra-CC spatial bundling is not applied to the remaining SCC (i.e., CC #1) and a PCC. Therefore, the UE can feed back more accurate ACK/NACK information to the BS.

Herein, a unit of applying the intra-CC spatial bundling may be a PDSCH unit (i.e., applied in an individual PDSCH unit), a CC unit (i.e., applied to all PDSCHs in the same CC), or a subframe unit (i.e., applied to all PDSCHs in the same subframe).

Meanwhile, an order of applying the intra-CC spatial bundling may be applied in a predetermined (or preset) CC order (e.g., in case of bundling in the CC unit, whether to apply bundling to one CC may be determined and then whether to apply bundling to a next CC may be determined). In this case, since there is a higher possibility that a PDSCH of a PCC is more frequently scheduled than being scheduled to another CC other than the PCC, it is more preferred to maintain individual ACK/NACK of CWs transmitted via the PCC, if possible, in terms of data transmission efficiency. Therefore, the intra-CC spatial bundling for the PCC is preferably applied at the end. For example, in a case where an index value (i.e., a CIF value including in a PDCCH) is given as 0 if it indicates a PCC, and is given as 1, 2, etc., in that order, if it indicates an SCC, the intra-CC spatial bundling can be performed at the end on a PCC of which an index value is 0. For this, whether to apply the intra-CC spatial bundling is determined in sequence starting from a CC having a greatest index. That is, the intra-CC spatial bundling can be performed in an orderly manner starting from an SCC having a greatest CIF value to a PCC having a smallest CIF value.

For another example, a method can be considered in which, if the intra-CC spatial bundling is required, the intra-CC spatial bundling is first applied to all SCCs and thereafter the intra-CC spatial bundling is applied to a PCC only when exceeding a maximum transmission amount. Alternatively, it is also possible to consider a method of determining whether to apply the intra-CC spatial bundling for each CC.

In the aforementioned methods, whether to apply bundling can be determined according to the number of DL subframes mapped to one UL subframe. For example, assume that a DL:UL ratio is M:1. If M is 1, the ratio of the DL subframe and the UL subframe is 1:1. Accordingly, ACK/NACK may not be necessarily transmitted by performing bundling.

Therefore, the UE may determine whether to apply ACK/NACK bundling according to whether M is 1 or not. That is, the aforementioned Methods 1-1 to 2-5 may be applied if M is a natural number greater than 1, and an ACK/NACK transmission method used in FDD or the conventional method may be used if M is 1. For example, in a case where two CCs are assigned as shown in FIG. 15 and FIG. 16, since the number of bits of ACK/NACK does not exceeds 4, the intra-CC spatial bundling is not used if M=1, the intra-CC spatial bundling is used if M=2, and additional bundling other than the intra-CC spatial bundling is used if M=3 or higher.

Alternatively, it is also possible to use the aforementioned Methods 1-1, 1-2, 1-3, and 1-4 if M=1, and to use the aforementioned Methods 2-1, 2-2, 2-3, 2-4, and 2-5 if M is greater than 1. If M=1, since ACK/NACK bundling is not applied, a DAI can be used for other purposes. The DAI can be used as an ARI.

Alternatively, a method of turning ON/OFF the intra-CC spatial bundling can be used in such a manner that, if M is greater than 1, the intra-CC spatial bundling is automatically performed, and if M is 1, the intra-CC spatial bundling is not performed. This method can be applied to a channel selection mechanism based on PUCCH resource selection.

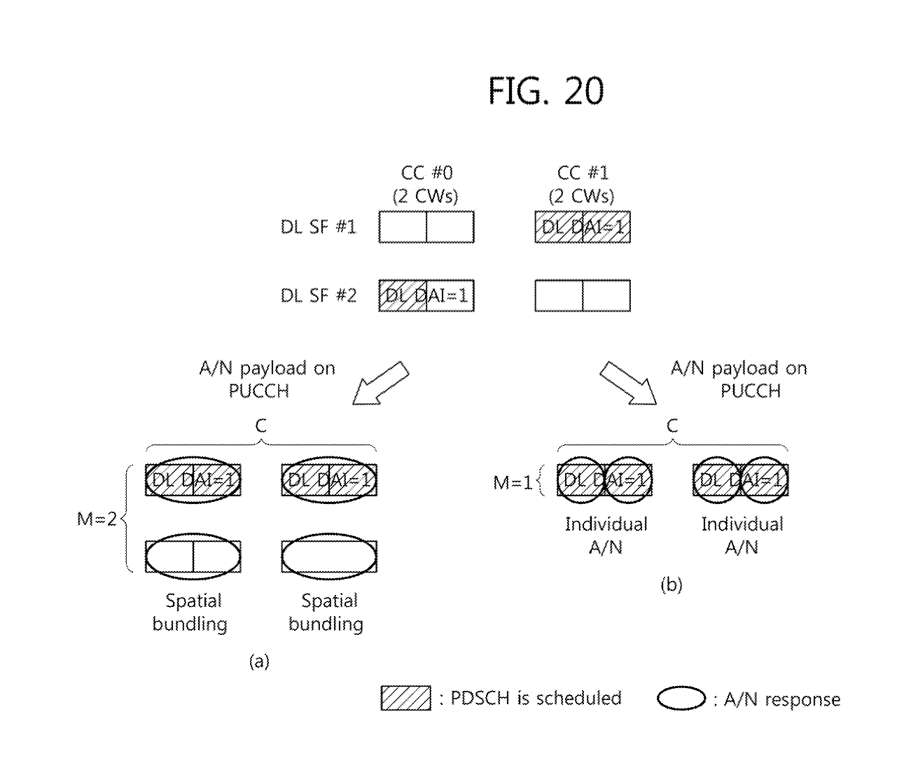

FIG. 20 shows an example of applying the conventional method and the present invention when transmitting ACK/NACK by using a channel selection mechanism based on PUCCH resource selection.

Referring to FIG. 20, if a UE transmits ACK/NACK by using the channel selection mechanism, whether to apply intra-CC spatial bundling is determined based on M, i.e., the number of DL subframes mapped to a UL subframe. That is, FIG. 20(a) shows a case where M=2 and the intra-CC spatial bundling is applied, and FIG. 20(b) shows a case where M=1 and the intra-CC spatial bundling is not applied. Although a case of M=2 is shown in FIG. 20(a), the present invention is not limited thereto, and thus the intra-CC spatial bundling can also be applied when M=3, 4, or 9.

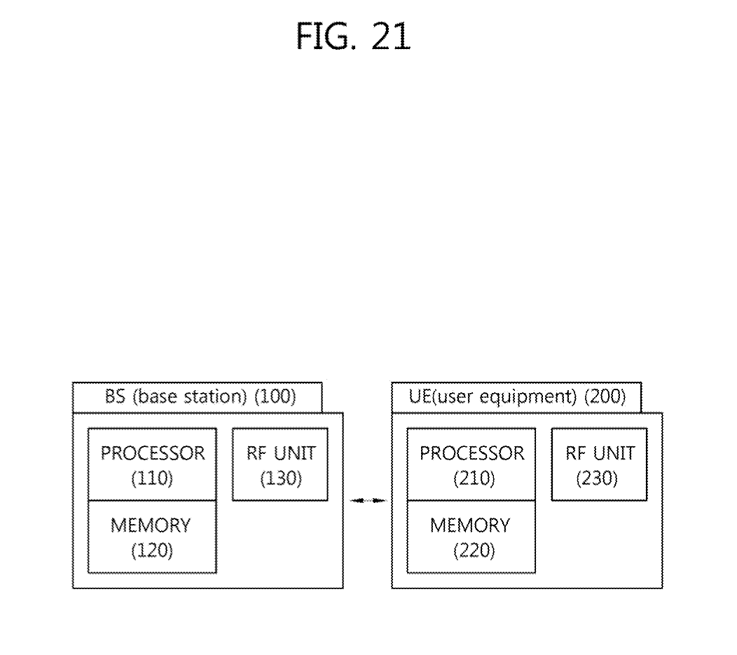

FIG. 21 is a block diagram showing a wireless communication system according to an embodiment of the present invention.

A BS 100 includes a processor 110, a memory 120, and a radio frequency (RF) unit 130. The processor 110 implements the proposed functions, processes, and/or methods. Layers of a radio interface protocol can be implemented by the processor 110. The processor 110 can report an ACK/NACK transmission method to a UE, and can transmit a plurality of PDSCHs via a plurality of serving cells. Each PDSCH can transmit one or two codewords according to a transmission mode. In addition, the processor 110 can receive ACK/NACK for the plurality of PDSCHs from the UE. The memory 120 is coupled to the processor 110, and stores a variety of information for driving the processor 110. The RF unit 130 is coupled to the processor 110, and transmits and/or receives a radio signal.

A UE 200 includes a processor 210, a memory 220, and an RF unit 230. The processor 210 implements the proposed functions, processes, and/or methods. Layers of a radio interface protocol can be implemented by the processor 210. The processor 210 receives a plurality of codewords via serving cells, and generates ACK/NACK information indicating reception acknowledgement for each of the plurality of codewords. The generated ACK/NACK information is transmitted through a bundling process. In this case, the bundling process can be performed sequentially on a part or entirety of ACK/NACK information until an information amount thereof is less than or equal to a predetermined transmission amount. The bundled ACK/NACK information is transmitted according to the ACK/NACK transmission method. The memory 220 is coupled to the processor 210, and stores a variety of information for driving the processor 210. The RF unit 230 is coupled to the processor 210, and transmits and/or receives a radio signal.

The processors 110 and 210 may include an application-specific integrated circuit (ASIC), a separate chipset, a logic circuit, and/or a data processing unit. The memories 120 and 220 may include a read-only memory (ROM), a random access memory (RAM), a flash memory, a memory card, a storage medium, and/or other equivalent storage devices. The RF units 130 and 230 may include a base-band circuit for processing a radio signal. When the embodiment of the present invention is implemented in software, the aforementioned methods can be implemented with a module (i.e., process, function, etc.) for performing the aforementioned functions. The module may be stored in the memories 120 and 220 and may be performed by the processors 110 and 210. The memories 120 and 220 may be located inside or outside the processors 110 and 210, and may be coupled to the processors 110 and 210 by using various well-known means. Although the aforementioned exemplary system has been described on the basis of a flowchart in which steps or blocks are listed in sequence, the steps of the present invention are not limited to a certain order. Therefore, a certain step may be performed in a different step or in a different order or concurrently with respect to that described above. Further, it will be understood by those ordinary skilled in the art that the steps of the flowcharts are not exclusive. Rather, another step may be included therein or one or more steps may be deleted within the scope of the present invention.

The aforementioned embodiments include various exemplary aspects. Although all possible combinations for representing the various aspects cannot be described, it will be understood by those skilled in the art that other combinations are also possible. Therefore, all replacements, modifications and changes should fall within the spirit and scope of the claims of the present invention.

1. A method of transmitting acknowledgement/not-acknowledgement (ACK/NACK) of a user equipment to which a plurality of cells are assigned in a wireless communication system operating with time division duplex (TDD), the method comprising:
receiving a plurality of codewords via a plurality of serving cells;
generating ACK/NACK information indicating reception acknowledgement for each codeword;
bundling the generated ACK/NACK information; and
transmitting the bundled ACK/NACK information,
wherein the bundling is sequentially performed on a part or entirety of the generated ACK/NACK information until an amount of the ACK/NACK information is less than or equal to a predetermined transmission amount.

2. The method of claim 1,
wherein the plurality of serving cells are identified by a carrier indication field value, and
wherein the bundling is performed on ACK/NACK information for a plurality of codewords received in the same downlink subframe starting from a serving cell of which a carrier indication field value is the greatest among the plurality of serving cells.

3. The method of claim 2, wherein a serving cell of which a carrier indication field value is the smallest among the plurality of serving cells is a primary cell.

4. The method of claim 3, wherein the primary cell is subjected to bundling at the end.

5. The method of claim 1, wherein the bundling is performed with ACK if all of the plurality of codewords are successfully received in the same downlink subframe with respect to at least one serving cell among the plurality of serving cells, and otherwise is performed with NACK.

6. The method of claim 1, wherein the bundled ACK/NACK information is transmitted by using any one of a channel selection mechanism based on physical uplink control channel (PUCCH) resource selection and a mechanism of using a PUCCH format 3.

7. A method of transmitting acknowledgement/not-acknowledgement (ACK/NACK) of a user equipment to which a plurality of serving cells are assigned in a wireless communication system operating with time division duplex (TDD), the method comprising:
receiving at least one codeword via a first serving cell;
receiving at least one codeword via a second serving cell; and
transmitting ACK/NACK for the codewords received via the first serving cell and the second serving cell,
wherein the first serving cell and the second serving cell have an M:1 relation (where M is a natural number) between a downlink subframe for receiving the codewords and an uplink subframe mapped to the downlink subframe and for transmitting ACK/NACK,
wherein if M is 1, ACK/NACK for the plurality of codewords received in the same subframe is transmitted, and
wherein if M is greater than 1, ACK/NACK for the plurality of codewords received in the same subframe is transmitted by performing bundling.

8. The method of claim 7, wherein the first serving cell is a primary cell.

9. The method of claim 8, wherein a first physical downlink control channel (PDCCH) for scheduling a codeword received via the first serving cell and a second PDCCH for scheduling a codeword received via the second serving cell are received via the primary cell.

10. The method of claim 9, wherein a plurality of radio resources are allocated so that ACK/NACK for codewords received via the first serving cell and the second serving cell can be transmitted on the basis of a radio resource for receiving the first PDCCH and a radio resource for receiving the second PDCCH.
